(19) United States
(12) Patent Application Publication
(10) Pub. No.: US 2026/0254504 A1
(43) Pub. Date: Aug. 27, 2026

(54) METHODS FOR PROCESSING CHANNEL STATE INFORMATION REPORT, COMMUNICATION NODE AND STORAGE MEDIUM

(71) Applicant: ZTE CORPORATION, Guangdong (CN)

(72) Inventors: Yong LI, Guangdong (CN); Zhaohua LU, Guangdong (CN); Lun LI, Guangdong (CN); Guozeng ZHENG, Guangdong (CN)

(73) Assignee: ZTE CORPORATION, Guangdong (CN)

(21) Appl. No.: 19/489,717

(22) PCT Filed: Mar. 27, 2024
(86) PCT No.: PCT/CN2024/083974

§ 371 Date: Dec. 3, 2025

(30) Foreign Application Priority Data
Jun. 20, 2023 (CN) 202310734941.7

(51) Int. Cl. H04B 7/06; H04L 5/00

(52) U.S. Cl. CPC H04B 7/0626; H04L 5/0094

(57) ABSTRACT

Provided are a method for processing CSI reports, a communication node and a storage medium. The method for processing CSI reports comprises: receiving configuration information sent by a second communication node; determining a concurrent quantity of CSI processing units according to the configuration information; and processing the CSI reports with at least one CSI processing unit concurrently, where the number of the at least one CSI processing unit is equal to the concurrent quantity.

### TECHNICAL FIELD

The present disclosure relates to the technical field of communication, and for example, relates to a method for processing channel state information report, a communication node and a storage medium.

### BACKGROUND

In the 4th generation (4G) wireless communication technology and the 5th generation (5G) wireless communication technology, a base station can determine a strategy for data transmission according to a channel state information (CSI) report sent by a terminal, and performs data transmission according to the determined strategy, thus improving the efficiency of data transmission. The communication process between the base station and the terminal can be as follows: the base station sends a reference signal; the terminal measures the reference signal, determines the CSI from the base station to the terminal, generates a CSI report and sends the CSI report to the base station; and the base station receives the CSI report sent by the terminal. The base station determines the strategy for data transmission according to the channel state indicated by the received CSI report, and performs data transmission according to the determined strategy, thus improving the efficiency of data transmission. The accuracy of the channel state indicated by the CSI report affects the strategy for data transmission determined by the base station, resulting in affecting the efficiency of data transmission. The more comprehensive the CSI report received by the base station is, the more beneficial it is for the base station to determine an appropriate strategy for data transmission, thus improving the system performance. Therefore, the base station expects the terminal to report multiple CSI reports in a short time.

The terminal determines the CSI report through a CSI processing unit. However, how to manage the CSI processing unit to process the CSI report to improve the processing efficiency of the CSI report is a problem to be solved.

### SUMMARY

The embodiments of the present disclosure provide a method for processing CSI reports which is applied to a first communication node and includes the following:

Configuration information sent by a second communication node is received; a concurrent quantity of CSI processing units is determined according to the configuration information; and the CSI reports are processed using at least one CSI processing unit, where the number of the at least one CSI processing unit is equal to the concurrent quantity.

The embodiments of the present disclosure provide a method for processing CSI reports which is applied to a second communication node, and includes the following:

Configuration information is sent to a first communication node; and the CSI reports processed according to the configuration information and sent by the first communication node are received, where the CSI reports are processed by the first communication node using at least one CSI processing unit concurrently, the number of the at least one CSI processing unit is equal to a concurrent quantity of CSI processing units, and the concurrent quantity is determined by the first communication node according to the configuration information.

The embodiments of the present disclosure provide a first communication node including a processor; the processor, when executing a computer program, is configured to implement the method for processing CSI reports of any one of the above embodiments.

The embodiments of the present disclosure provide a second communication node including a processor; the processor, when executing a computer program, is configured to implement the method for processing CSI reports of any one of the above embodiments.

The embodiments of the present disclosure further provide a computer-readable storage medium storing a computer program. When the computer program is executed by a processor, the method for processing CSI reports of any of the above embodiments is implemented.

### BRIEF DESCRIPTION OF DRAWINGS

FIG. 1 is a schematic diagram of a networking of a wireless communication system according to an embodiment of the present disclosure.

FIG. 2 is a flowchart of a method for processing CSI reports according to an embodiment of the present disclosure.

FIG. 3 is another flowchart of a method for processing CSI reports according to an embodiment of the present disclosure.

FIG. 4 is yet another interactive schematic diagram of a method for processing CSI reports according to an embodiment of the present disclosure.

FIG. 5 is a schematic structural diagram of an apparatus for processing CSI reports according to an embodiment of the present disclosure.

FIG. 6 is another schematic structural diagram of an apparatus for processing CSI reports according to an embodiment of the present disclosure.

FIG. 7 is a schematic structural diagram of a terminal according to an embodiment of the present disclosure.

FIG. 8 is a schematic structural diagram of a base station according to an embodiment of the present disclosure.

### DETAILED DESCRIPTION

The specific embodiments described herein are intended to explain the present disclosure. The embodiments of the present disclosure will be described hereinafter with reference to the drawings. The terms “first” and “second” in the present disclosure are intended to distinguish between similar objects but do not necessarily indicate a specific order or sequence. The data used in such a way are interchangeable in proper circumstances, so that the embodiments of the present disclosure described herein can be implemented in an order other than those illustrated or described.

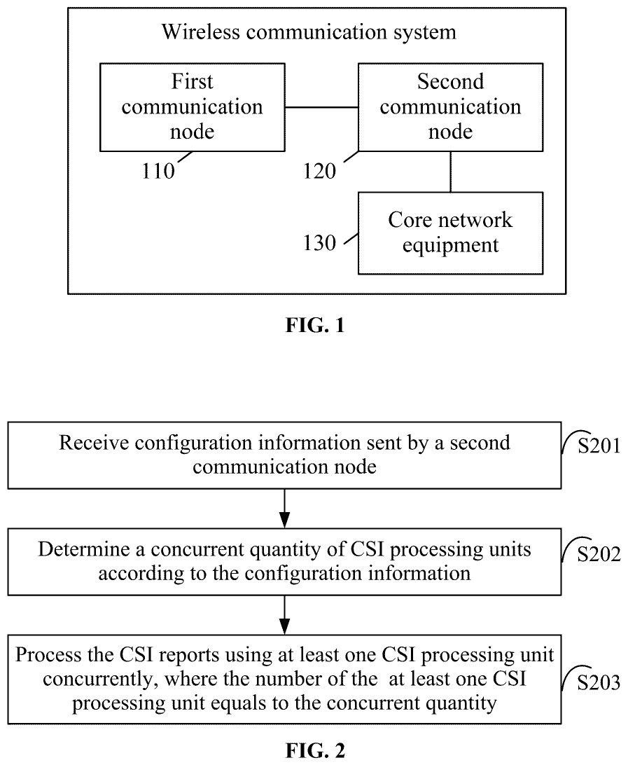

The method for processing CSI reports provided by the present disclosure can be applied to various wireless communication systems, such as a long term evolution (LTE) system, a 4G system, a 5G system, a LTE-5G hybrid architecture system, a New Radio (NR) system of 5G, and a new communication system emerging in future communication development, e.g., a 6th-generation (6G) system. FIG. 1 is a schematic diagram of a networking of a wireless communication system according to an embodiment of the present disclosure. As shown in FIG. 1, the wireless communication system includes a first communication node 110 and a second communication node 120. In the wireless communication scenario, the first communication node 110 communicates with the second communication node 120 through a wireless channel.

For example, the first communication node is a terminal, and the second communication node is access network equipment, such as a base station. The base station communicates with the terminal through the wireless channel. For another example, the first communication node is a terminal, the second communication node is a wireless router, and the wireless router communicates with the terminal through the wireless channel. For another example, the first communication node is a first base station, the second communication node is a second base station, and the first base station communicates with the second base station through the wireless channel. For another example, the first communication node is a first terminal, the second communication node is a second terminal, and the first terminal communicates with the second terminal through the wireless channel. For another example, the first communication node is a repeater, the second communication node is a base station, and the base station communicates with the repeater through the wireless channel. For another example, the first communication node is a terminal, the second communication node is a repeater, and the repeater communicates with the terminal through the wireless channel. For another example, the first communication node is a first repeater, the second communication node is a second repeater, and the first repeater communicates with the second repeater through the wireless channel. For another example, the first communication node is a base station, the second communication node is a satellite, and the satellite communicates with the base station through the wireless channel. For another example, the first communication node is a satellite, the second communication node is a base station, and the base station communicates with the satellite through the wireless channel. For another example, the first communication node is a terminal, the second communication node is a satellite, and the satellite communicates with the terminal through the wireless channel. For another example, the first communication node is a satellite, the second communication node is a terminal, and the terminal communicates with the satellite through the wireless channel. For another example, the first communication node is ground equipment, the second communication node is an aircraft, and the aircraft communicates with the ground equipment through the wireless channel. For another example, the first communication node is a first aircraft, the second communication node is a second aircraft, and the first aircraft communicates with the second aircraft through the wireless channel.

When the first communication node is the terminal, the terminal may be a equipment with wireless transceiving function, may be deployed on land (such as indoors or outdoors, handheld, wearable or vehicle-mounted, etc.); may also be deployed on the water surface (such as ships, etc.); and may also be deployed in the air (such as airplanes, balloons and satellites, etc.). In some examples, the terminal may be any user terminal that can be networked such as a passive terminal, a user equipment (UE), a mobile phone, a mobile station, a tablet computer, a notebook computer, an ultra-mobile personal computer (UMPC), a handheld computer, a netbook, and a personal digital assistant (PDA); or may be a virtual reality (VR) terminal, an augmented reality (augmented reality, AR) terminal, a wireless terminal in industrial control, a wireless terminal in self driving, a wireless terminal in remote medical, a wireless terminal in smart grid, a wireless terminal in transportation safety, a wireless terminal in smart city, a wireless terminal in smart home, and etc.; or, may be an internet of things node in the IoT, a vehicle-mounted communication equipment in the internet of vehicles, an entertainment and game equipment or system, a global positioning system equipment, and etc. The embodiments of the present disclosure do not limit the technologies and equipment forms adopted by the terminal. Moreover, the terminal may also be referred to as a terminal equipment.

When the second communication node is the access network equipment, the access network equipment may be a reader/writer, a base station, an evolved base station (evolved NodeB, eNB or eNodeB) in long term evolution advanced (LTEA), a transmission reception point (TRP), a base station or a next generation NodeB (gNB) in a 5G mobile communication system, a base station in a future mobile communication system or an access node in a wireless fidelity (WiFi) system, etc. The base station may include various network-side equipments (such as a macro base station, a micro base station, a home base station, a wireless remote station, a router, a WiFi equipment, a primary cell and a secondary cell), and a location management function (LMF) equipment. The base station may also be a module or a unit implementing some functions of the base station. For example, the base station may be a central unit (CU) or a distributed unit (DU). The embodiments of the present disclosure do not limit the technologies and equipment forms adopted by the access network equipment. Moreover, the access network equipment may be simply referred to as the base station.

The wireless communication system may further include the core network equipment 130. The second communication node 120 may be connected to the core network equipment 130. The core network equipment 130 may include an access and mobility management network element and a session management network element. For example, the first communication node 110 may access the core network through the second communication node 120 to achieve data transmission.

The embodiments of the present disclosure provide a method for processing CSI reports which is employed in the above wireless communication system, which can achieve that the processing efficiency of CSI reports is improved, and the efficiency of data transmission is further improved, by that configuration information sent by the second communication node is received, a concurrent quantity of CSI processing units is determined according to the configuration information, and the CSI reports are processed using at least one CSI processing unit concurrently, where the number of the at least one CSI processing unit is equal to the concurrent quantity.

The method for processing CSI reports, a communication node and technical effects thereof are described hereinafter.

FIG. 2 is a flowchart of a method for processing CSI reports according to an embodiment of the present disclosure. The method for processing CSI reports provided in the present embodiment is applicable to a first communication node. In this example, the first communication node (also referred to as the first communication node equipment) may be the terminal equipment, such as the UE. The method for processing CSI reports includes S201-S203.

S201: Configuration information sent by a second communication node is received.

The second communication node in the present embodiment may be the access network equipment, such as the base station.

Before S201, the first communication node sends capability information to the second communication node. The second communication node determines the configuration information according to the capability information sent by the first communication node and sends the configuration information to the first communication node. The capability information in the present embodiment refers to the support capability information of the first communication node.

In an example, the capability information in the present embodiment may include at least one of the following: the quantity of the CSI processing units, the types of the CSI processing units, and the quantity of the CSI processing units corresponding to each type of the CSI processing unit. The first communication node processes the CSI reports using CSI processing units. The quantity of the CSI processing units is equal to a concurrent quantity for CSI calculations supported by the first communication node, i.e., the concurrent quantity for CSI calculations supported by the first communication node, which also means that the first communication node supports performing concurrent CSI calculations whose quantity is equal to the concurrent quantity. The types of the CSI processing unit refer to the categories of the CSI processing units.

In one manner, a type of the CSI processing units is determined according to a manner of determining the concurrency quantity for CSI calculations. For example, the type of the CSI processing units is determined as a type corresponding to the concurrency quantity determined according to a quantity of the CSI-RS resources, as a type corresponding to the concurrency quantity determined according to a quantity of the precoding matrices, as a type corresponding to the concurrency quantity determined according to a quantity of ranks of precoding matrices, as a type corresponding to the concurrency quantity determined according to a quantity of layers of precoding matrices, as a type corresponding to the concurrency quantity determined according to a quantity of codebooks of the precoding matrices, as a type corresponding to the concurrency quantity determined according to a quantity of machine learning models, as a type corresponding to the concurrency quantity determined according to a quantity of overheads of precoding matrices, as a type corresponding to the concurrency quantity determined according to a quantity of frequency domain units, or, as a type corresponding to the concurrency quantity determined according to a quantity of the precoding matrix acquisition schemes.

In another manner, a type of the CSI processing units is determined according to CSI reports contents. For example, the type of the CSI processing units is determined as a type corresponding to the CSI report content being the precoding matrices of one transmitting panel, a type corresponding to the CSI report content being the precoding matrices of two transmitting panels, a type corresponding to the CSI report content being the precoding matrices of Y transmitting panels, a type corresponding to the CSI report content being a precoding matrices type corresponding to one codebooks type, a type corresponding to the CSI report content being a precoding matrices type corresponding to two codebooks types, a type corresponding to the CSI report content being a precoding matrices type corresponding to Y codebooks types, a type corresponding to the CSI report content being a precoding matrices type corresponding to one overhead, a type corresponding to the CSI report content being a precoding matrices type corresponding to two overheads, a type corresponding to the CSI report content being a precoding matrices type corresponding to Y overheads, a type corresponding to the CSI report content being a precoding matrices type corresponding to one frequency domain unit, a type corresponding to the CSI report content being a precoding matrices type corresponding to two frequency domain units, a type corresponding to the CSI report content being a precoding matrices type corresponding to Y frequency domain units, a type corresponding to the CSI report content being a precoding matrices type corresponding to one machine learning model, a type corresponding to the CSI report content being a precoding matrices type corresponding to two machine learning models, a type corresponding to the CSI report content being a precoding matrices type corresponding to Y machine learning models, a type corresponding to the CSI report content being a precoding matrices type corresponding to one precoding matrix acquisition scheme, a type corresponding to the CSI report content being a precoding matrices type corresponding to two precoding matrix acquisition schemes, a type corresponding to the CSI report content being a precoding matrices type corresponding to Y precoding matrix acquisition schemes, or a type corresponding to the CSI report content being a combination of the precoding matrices determined according to codebooks and precoding matrices determined by machine learning models; and Y is a non-negative integer.

The type of the CSI processing unit indicates the content processed by one CSI calculation in the CSI calculations concurrency, i.e., indicates the content corresponding to one CSI processing unit in the CSI calculation concurrency structure.

The quantity of the CSI processing units corresponding to the type of the CSI processing unit is a concurrent quantity for CSI calculations corresponding to the supported type of CSI processing units. One example is as follows: the quantity of the CSI processing units of type 1 is Z1, indicating that the concurrent quantity for CSI calculations corresponding to the supported type 1 of CSI processing units is Z1, and for example, the quantity of the CSI processing units of type 1 is 5, indicating that the concurrent quantity for CSI calculations corresponding to the supported type 1 of CSI processing units is 5. Another example is as follows: the quantity of the CSI processing units of type 2 is Z2, indicating that the concurrent quantity for CSI calculations corresponding to the supported type 2 of CSI processing units is Z2, and for example, the quantity of the CSI processing units of type 2 is 7, indicating that the concurrent quantity for CSI calculations corresponding to the supported type 2 of CSI processing units is 7.

The quantity of the CSI processing units of type 1 is Z1, and the quantity of the CSI processing units of type 2 is Z2. In an embodiment, the first communication node has Z1 CSI processing units of type 1 and Z2 CSI processing units of type 2. In other words, the first communication node simultaneously supports performing Z1 CSI calculations concurrently corresponding to the CSI processing units of type 1 and supports performing Z2 CSI calculations concurrently corresponding to the CSI processing units of type 2. The quantity of the CSI processing units of type 1 is Z1, and the quantity of the CSI processing units of type 2 is Z2. In another embodiment, the first communication node has Z1 CSI processing units of type 1 or Z2 CSI processing units of type 2. In other words, the first communication node can support performing Z1 CSI calculations concurrently corresponding to the CSI processing units of type 1 or performing Z2 CSI calculations concurrently corresponding to the CSI processing units of type 2, or, the first communication node can support both performing Z1 CSI calculations concurrently corresponding to the CSI processing units of type 1 and performing Z2 CSI calculations concurrently corresponding to the CSI processing units of type 2, however the first communication node can only support concurrent CSI calculations corresponding to one of the two types of the CSI processing units at a same time. Z1 and Z2 are non-negative integers.

In an embodiment, the configuration information may include at least one of the following: information of the CSI-RS resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition schemes, groups of precoding matrix acquisition schemes, or information for monitoring precoding matrix acquisition schemes.

The information of the CSI-RS resources is used to indicate at least one of the following: the CSI-RS resources in a CSI-RS resource set corresponding to the CSI reports, the quantity of the CSI-RS resources in a CSI-RS resource set corresponding to the CSI reports, the quantity of the CSI-RS resources in the CSI reports, or a range of the candidate indexes of the CSI-RS resources in the CSI reports. The difference between the CSI-RS resources in the CSI-RS resource set corresponding to the CSI reports and the CSI-RS resources in the CSI reports is that the CSI-RS resources in the CSI-RS resource set corresponding to the CSI reports refer to candidate CSI-RS resources corresponding to the CSI reports, while the CSI-RS resources in the CSI reports refer to selected CSI-RS resources in the CSI reports. The CSI-RS resources in the CSI reports are a subset of the CSI-RS resources in the CSI-RS resource set corresponding to the CSI reports.

The overheads of the precoding matrices refer to the resources required after the precoding matrices are compressed. In an example, the overheads of the precoding matrices may refer to the quantity of bits required after the precoding matrices are compressed.

The machine learning models are used to output the precoding matrices. The machine learning models in the present embodiment may be models trained by various machine learning methods. For example, the machine learning models may be an artificial intelligence model, such as a neural network and a convolutional neural network. The machine learning models in the present embodiment may be pre-configured in the first communication node, may be sent to the first communication node by the second communication node when the first communication node is required to use the machine learning models, or may be sent to the first communication node by a third communication node when the first communication node is required to use the machine learning models. The third communication node may be a server and other devices communicatively connected to the first communication node.

The frequency domain units in the present embodiment may be a frequency domain unit defined according to requirements. For example, the frequency domain units in the present embodiment may be a resource block (RB), a subband, or a bandwidth part.

The information for monitoring precoding matrix acquisition schemes includes at least one of the following: whether to monitor and report the precoding matrix acquisition schemes, the content monitored and reported, the format of the monitoring and reporting, etc.

S202: the concurrent quantity of CSI processing units is determined according to the configuration information.

S203: the CSI reports are processed using at least one CSI processing unit, where the number of the at least one CSI processing unit is equal to the concurrent quantity.

The first communication node may perform one CSI calculation at the same time, and may also perform multiple CSI calculations at the same time. Performing multiple CSI calculations at the same time is referred to as concurrency of CSI calculations or CSI calculations concurrent execution, concurrent CSI calculations, or concurrent execution of CSI calculations. M CSI calculations are performed by the first communication node at the same time, referring to as the concurrency of M CSI calculations, or the concurrent quantity for CSI calculations being M, or performing CSI calculations with the concurrent quantity being M; and M is a non-negative integer. For example, one CSI calculation is performed by the first communication node at the same time, referring to as the concurrent quantity for CSI calculation being 1, or performing CSI calculation with the concurrent quantity being 1. For example, two CSI calculations are performed by the first communication node at the same time, referring to as the concurrent quantity for CSI calculations being 2, or performing CSI calculations with the concurrent quantity being 2. For example, three CSI calculations are performed by the first communication node at the same time, referring to as the concurrent quantity for CSI calculations being 3, or performing CSI calculations with the concurrent quantity being 3. In the case where M is 0, no CSI calculation is performed.

The first communication node can perform CSI calculations with the concurrent quantity being N, indicating that the first communication node supports CSI calculations with the concurrent quantity being N, indicating that the first communication node has N CSI processing units, and N is a non-negative integer. L CSI calculations are concurrent, indicating that L CSI processing units are occupied; and L is a non-negative integer. The first communication node has N CSI processing units, where L CSI processing units are occupied, so the first communication node still has N-L CSI processing units unoccupied, that is, the first communication node can still perform CSI calculations with the concurrent quantity being N-L, in other words, the first communication node can still support CSI calculations with the concurrent quantity being of N-L.

In the present embodiment, CSI reports are processed using at least one CSI processing unit, where the number of the at least one CSI processing unit is equal to the concurrent quantity, indicating that CSI calculations performed by the CSI processing units are equal to the concurrent quantity. The CSI processing units corresponding to the concurrent quantity indicate that the quantity of the CSI processing units is equal to the concurrent quantity. Processing CSI reports in the present embodiment may also be described as generating CSI reports or determining CSI reports. The execution result of the CSI calculations is a CSI report. One CSI report or a group of CSI reports is generated by performing CSI calculations using CSI processing units corresponding to the concurrent quantity O; and a group of CSI reports includes multiple CSI reports. The present embodiment is not limited thereto.

In the present embodiment, the first communication node performs multiple CSI calculations. For example, the first communication node measures multiple CSI-RS resources, or measures reference signals on multiple CSI-RS resources. For another example, the first communication node calculates multiple precoding matrices. For another example, the first communication node processes precoding matrices of multiple ranks. For another example, the first communication node processes precoding matrices of multiple layers. For another example, the first communication node calculates precoding matrices according to multiple codebooks of precoding matrices. For another example, the first communication node processes the precoding matrices using multiple machine learning models, such as neural networks. For another example, the first communication node processes the precoding matrices with multiple different overheads. For another example, the first communication node processes CSI on multiple frequency domain units. For another example, the first communication node acquires the precoding matrices in multiple manners. For another example, the first communication node monitors multiple precoding matrix acquisition schemes. The first communication node acquires the precoding matrices in multiple manners: for example, one manner is to acquire the precoding matrices according to a first codebook of precoding matrices, another manner is to acquire the precoding matrices according to a second codebook of precoding matrices, another manner is to acquire the precoding matrices using a first machine learning model, another manner is to acquire the precoding matrices using a second machine learning model, another manner is to acquire the precoding matrices based on a first overhead, and another manner is to acquire the precoding matrices based on a second overhead. For another example, one manner is to acquire the precoding matrices according to the first codebook of precoding matrices and the first overhead, another manner is to acquire the precoding matrices according to the first codebook of precoding matrices and the second overhead, another manner is to acquire the precoding matrices according to the second codebook of precoding matrices and the first overhead, and another manner is to acquire the precoding matrices according to the second codebook of precoding matrices and the second overhead. For another example, one manner is to acquire the precoding matrices according to the first overhead and using the first machine learning model, another manner is to acquire the precoding matrices according to the first overhead and using the second machine learning model, another manner is to acquire the precoding matrices according to the second overhead and using the first machine learning model, and another manner is to acquire the precoding matrices according to the second overhead and using the second machine learning model.

In S202, the first communication node determines the concurrent quantity of CSI processing units according to the configuration information.

In one implementation, in S202, the type and concurrent quantity of the CSI processing units are determined according to the configuration information. Correspondingly, S203 may concurrently process CSI reports using the CSI processing units with the concurrent quantity being corresponding to the type of CSI processing units.

In another implementation, in S202, when the concurrent quantity is determined, the type of CSI processing units is also determined. Correspondingly, in S203, the CSI reports may be processed using CSI processing units corresponding to the concurrent quantity, and the CSI processing units may be the CSI processing units corresponding to a determined type of the CSI processing units.

The implementation process of determining the concurrent quantity of CSI processing units above is illustrated with several examples.

### Example 2.1

In the case where the configuration information includes the information of the CSI-RS resources or the groups of the CSI-RS resources, the implementation process of S202 includes determining the concurrent quantity according to the quantity of the CSI-RS resources or the quantity of the groups of the CSI-RS resources.

Correspondingly, the implementation process of S203 may include that the first communication node determines the concurrent quantity of the CSI processing units according to CSI-RS resources, concurrently measures M CSI-RS resources using CSI processing units whose quantity is the concurrent quantity, or measures reference signals on M CSI-RS resources.

One manner to determine the concurrent quantity O includes determining the quantity of the CSI-RS resources as the concurrent quantity, that is, the concurrent quantity O is equal to the quantity of the CSI-RS resources. For example, one CSI calculation corresponds to one CSI-RS resource, and M CSI calculations correspond to M CSI-RS resources. In other words, the first communication node performs O CSI calculations at the same time, O is equal to the quantity M of the CSI-RS resources, and one CSI calculation corresponds to one CSI-RS resource.

Another manner to determine the concurrent quantity O includes determining a sum of the quantity of the CSI-RS resources and a preset first value as the concurrent quantity, that is, the concurrent quantity O is equal to the quantity of the CSI-RS resources plus the preset first value, or equal to the sum of the quantity of the CSI-RS resources and the first value which is preset. The first value may be an integer greater than 0. In an example, the first value may be 1. For example, one CSI calculation corresponds to one CSI-RS resource, M CSI calculations correspond to M CSI-RS resources, and another CSI calculation corresponds to one other purpose. In other words, the first communication node performs O CSI calculations at the same time, O is equal to the quantity M of the CSI-RS resources plus 1, where one CSI calculation corresponds to one CSI-RS resource and the other CSI calculations correspond to one other purpose. “Other purpose” here refers to other processing processes in the process of processing CSI reports besides measuring the CSI resources.

Another manner to determine the concurrent quantity O includes determining the greater one of the quantity of the CSI-RS resources and a preset second value as the concurrent quantity. In an example, the second value may be an integer greater than 1. For example, if the second value is 2, the concurrent quantity O is equal to the greater one of the quantity of the CSI-RS resources and 2.

Another manner to determine the concurrent quantity O includes determining the quantity of the groups of the CSI-RS resources as the concurrent quantity, that is, the concurrent quantity O is equal to the quantity of the groups of the CSI-RS resources. For example, M CSI-RS resources are divided into X groups, and the concurrent quantity O is equal to X. One CSI calculation corresponds to one group of CSI-RS resources, and X CSI calculations correspond to X groups of the CSI-RS resources. In other words, the first communication node performs O CSI calculations at the same time, O is equal to the quantity X of the groups of the CSI-RS resources, and one CSI calculation corresponds to one group of CSI-RS resources.

The groups of the CSI-RS resources include groups of CSI-RS resources generated by grouping in a manner of quantity-based even partitioning, or by grouping in a manner of computing-power-requirement-based even partitioning, or by grouping in a manner of CSI-processing-unit-computing-power-based matching partitioning.

One manner of dividing M CSI-RS resources into X groups includes that M CSI-RS resources are almost evenly divided into X groups. For example, 6 CSI-RS resources are divided into 2 groups, and each group of CSI-RS resources includes 3 CSI-RS resources. For example, 6 CSI-RS resources are divided into 3 groups, and each group of CSI-RS resources includes 2 CSI-RS resources. For example, 7 CSI-RS resources are divided into 2 groups, one group of CSI-RS resources includes 3 CSI-RS resources, and the other group of CSI-RS resources includes 4 CSI-RS resources. For example, 7 CSI-RS resources are divided into 3 groups, one group of CSI-RS resources includes 2 CSI-RS resources, another group of CSI-RS resources includes 2 CSI-RS resources, and another group of CSI-RS resources includes 3 CSI-RS resources. M CSI-RS resources are almost evenly divided into X groups, realizing the load balance of each CSI calculation. In other words, the load balance of each CSI processing unit can be realized, and the processing efficiency of CSI reports can be improved.

Another manner of dividing M CSI-RS resources into X groups includes that M CSI-RS resources are unevenly divided into X groups. The unevenly grouping includes: grouping in a manner of computing-power-requirement-based even partitioning, or grouping in a manner of CSI-processing-unit-computing-power-based matching partitioning.

For example, an example of 6 CSI-RS resources being unevenly divided into 3 groups of the CSI-RS resources:

| | |
|---|---|
| Group 1 of the CSI-RS resources | CSI-RS resource 1 |
| Group 2 of the CSI-RS resources | CSI-RS resource 2 |
| Group 3 of the CSI-RS resources | CSI-RS resource 3, CSI-RS resource 4, |
| | CSI-RS resource 5, CSI-RS resource 6 |

For example, another example of 6 CSI-RS resources being unevenly divided into 3 groups of the CSI-RS resources:

| | |
|---|---|
| Group 1 of the CSI-RS resources | CSI-RS resource 1 |
| Group 2 of the CSI-RS resources | CSI-RS resource 2, CSI-RS resource 3 |
| Group 3 of the CSI-RS resources | CSI-RS resource 4, CSI-RS resource 5, |
| | CSI-RS resource 6 |

For example, an example of 6 CSI-RS resources being unevenly divided into 2 groups of the CSI-RS resources:

| | |
|---|---|
| Group 1 of the CSI-RS resources | CSI-RS resource 1 |
| Group 2 of the CSI-RS resources | CSI-RS resource 2, CSI-RS resource 3, |
| | CSI-RS resource 4, CSI-RS resource 5, |
| | CSI-RS resource 6 |

For example, another example of 6 CSI-RS resources being unevenly divided into 2 groups of the CSI-RS resources:

| | |
|---|---|
| Group 1 of the CSI-RS resources | CSI-RS resource 1, CSI-RS resource 2 |
| Group 2 of the CSI-RS resources | CSI-RS resource 3, CSI-RS resource 4, |
| | CSI-RS resource 5, CSI-RS resource 6 |

For example, an example of 7 CSI-RS resources being unevenly divided into 3 groups of the CSI-RS resources:

| | |
|---|---|
| Group 1 of the CSI-RS resources | CSI-RS resource 1 |
| Group 2 of the CSI-RS resources | CSI-RS resource 2 |
| Group 3 of the CSI-RS resources | CSI-RS resource 3, CSI-RS resource 4, |
| | CSI-RS resource 5, CSI-RS resource 6, |
| | CSI-RS resource 7 |

For example, another example of 7 CSI-RS resources being unevenly divided into 3 groups of the CSI-RS resources:

| | |
|---|---|
| Group 1 of the CSI-RS resources | CSI-RS resource 1 |
| Group 2 of the CSI-RS resources | CSI-RS resource 2, CSI-RS resource 3 |
| Group 3 of the CSI-RS resources | CSI-RS resource 4, CSI-RS resource 5, |
| | CSI-RS resource 6, CSI-RS resource 7 |

For example, another example of 7 CSI-RS resources being unevenly divided into 3 groups of the CSI-RS resources:

| | |
|---|---|
| Group 1 of the CSI-RS resources | CSI-RS resource 1, CSI-RS resource 2 |
| Group 2 of the CSI-RS resources | CSI-RS resource 3, CSI-RS resource 4 |
| Group 3 of the CSI-RS resources | CSI-RS resource 5, CSI-RS resource 6, |
| | CSI-RS resource 7 |

For example, an example of 7 CSI-RS resources being unevenly divided into 2 groups of the CSI-RS resources:

| | |
|---|---|
| Group 1 of the CSI-RS resources | CSI-RS resource 1 |
| Group 2 of the CSI-RS resources | CSI-RS resource 2, CSI-RS resource 3, |
| | CSI-RS resource 4, CSI-RS resource 5, |
| | CSI-RS resource 6, CSI-RS resource 7 |

For example, another example of 7 CSI-RS resources being unevenly divided into 2 groups of the CSI-RS resources:

| | |
|---|---|
| Group 1 of the CSI-RS resources | CSI-RS resource 1, CSI-RS resource 2 |
| Group 2 of the CSI-RS resources | CSI-RS resource 3, CSI-RS resource 4, |
| | CSI-RS resource 5, CSI-RS resource 6, |
| | CSI-RS resource 7 |

In the case where different CSI-RS resources correspond to different computing loads, i.e., different CSI-RS resources have different computing power requirements, M CSI-RS resources are divided into X groups in a manner of computing-power-requirement-based even partitioning, so that balance of the computing power requirement of each group of CSI-RS resources can be realized, and then the load balance of each CSI calculation can be realized. In this implementation, in the case where 3 groups of the CSI-RS resources are divided into, the difference between the computing power requirements of the CSI-RS resources in group 1 of the CSI-RS resources, in group 2 of the CSI-RS resources and in group 3 of the CSI-RS resources does not exceed a preset difference degree or a preset difference threshold. In other words, the computing power requirements of the CSI-RS resources in each group of CSI-RS resources are in balance. The computing power requirements of the CSI-RS resources in a group of the CSI-RS resources refer to a sum of the computing power requirement of each CSI-RS resource in the group of the CSI-RS resources.

In the case where the computing power of the CSI processing units responsible for each CSI calculation is not equal, M CSI-RS resources are divided into X groups in a manner of CSI-processing-unit-computing-power-based matching partitioning, so that the matching between the computing power of the CSI processing units and the computing power requirements of the groups of the CSI resources is realized, and then the processing efficiency of each CSI processing unit is improved. In this implementation, for example, in the case where 3 groups of the CSI-RS resources are divided into, the computing power requirements of the CSI-RS resources in the group 1 of the CSI-RS resources matches the computing power of the CSI processing unit 1, the computing power requirements of the CSI-RS resources in the group 2 of the CSI-RS resources matches the computing power of the CSI processing unit 2, and the computing power requirements of the CSI-RS resources in the group 3 of the CSI-RS resources matches the computing power of the CSI processing unit 3.

### Example 2.2

The implementation of S202 may include determining the quantity of the precoding matrices or the quantity of the groups of the precoding matrices according to the configuration information, and determining the concurrent quantity according to the quantity of the precoding matrices or the quantity of the groups of the precoding matrices.

The first communication node may determine the quantity of the precoding matrices or the quantity of the groups of the precoding matrices according to information related to the precoding matrices in the configuration information. The information related to the precoding matrices here may be, for example, at least one of the codebooks of the precoding matrices, groups of codebooks of precoding matrices, ranks of precoding matrices, groups of ranks of precoding matrices, overheads of precoding matrices, groups of overheads of precoding matrices, machine learning models, or groups of machine learning models.

Correspondingly, the implementation process of S203 may include that the first communication node determines the concurrent quantity of the CSI processing units according to the precoding matrices, and calculates M precoding matrices using at least one CSI processing unit whose quantity is equal to the concurrent quantity.

One manner to determine the concurrent quantity O includes determining the quantity of the precoding matrices as the concurrent quantity, that is, the concurrent quantity O is equal to the quantity of the precoding matrices. For example, one CSI calculation corresponds to one precoding matrix, and M CSI calculations correspond to M precoding matrices. In other words, the first communication node performs O CSI calculations at the same time, O is equal to the quantity M of the precoding matrices, and one CSI calculation corresponds to one precoding matrix.

Another manner to determine the concurrent quantity O includes determining a sum of the quantity of the precoding matrices and a third value which is preset as the concurrent quantity, that is, the concurrent quantity O is equal to the quantity of the precoding matrices plus the third value, or equal to the sum of the quantity of the precoding matrices and the third value. The third value may be an integer greater than 0. In an example, the third value may be 1. For example, one CSI calculation corresponds to one precoding matrix, M CSI calculations correspond to M precoding matrices, and another CSI calculation corresponds to one other purpose. In other words, the first communication node performs O CSI calculations at the same time, O is equal to the quantity M of the precoding matrices plus 1, where one CSI calculation corresponds to one precoding matrix and the other CSI calculations correspond to one other purpose. “Other purpose” here refers to other processing processes in the process of processing CSI reports besides calculting the precoding matrices.

Another manner to determine the concurrent quantity O includes determining the greater one of the quantity of the precoding matrices and a fourth value which is preset as the concurrent quantity. In an example, the fourth value may be an integer greater than 1. For example, if the fourth value is 2, the concurrent quantity O is equal to the greater one of the quantity of the precoding matrices and 2.

Another manner to determine the concurrent quantity O includes determining the quantity of the groups of the precoding matrices as the concurrent quantity, that is, the concurrent quantity O is equal to the quantity of the groups of the precoding matrices. For example, M precoding matrices are divided into X groups, and the concurrent quantity O is equal to X. One CSI calculation corresponds to one group of the precoding matrices, and X CSI calculations correspond to X groups of the precoding matrices. In other words, the first communication node performs O CSI calculations at the same time, O is equal to the quantity X of the groups of the precoding matrices, and one CSI calculation corresponds to one group of the precoding matrices.

The groups of the precoding matrices are generated by grouping in a manner of quantity-based even partitioning, or the groups of the precoding matrices are generated by grouping in a manner of computing-power-requirement-based even partitioning, or the groups of the precoding matrices are generated by grouping in a manner of CSI-processing-unit-computing-power-based matching partitioning.

One manner of dividing M precoding matrices into X groups includes that M precoding matrices are almost evenly divided into X groups. For example, 6 precoding matrices are divided into 2 groups, and each group of the precoding matrices includes 3 precoding matrices. For example, 6 precoding matrices are divided into 3 groups, and each group of the precoding matrices includes 2 precoding matrices. For example, 7 precoding matrices are divided into 2 groups, one group of the precoding matrices includes 3 precoding matrices, and the other group of the precoding matrices includes 4 precoding matrices. For example, 7 precoding matrices are divided into 3 groups, one group of the precoding matrices includes 2 precoding matrices, another group of the precoding matrices includes 2 precoding matrices, and another group of the precoding matrices includes 3 precoding matrices. M precoding matrices are almost evenly divided into X groups, realizing the load balance of each CSI calculation. In other words, the load balance of each CSI processing unit can be realized, and the processing efficiency of CSI reports can be improved.

Another manner of dividing M precoding matrices into X groups includes that M precoding matrices are unevenly divided into X groups. The unevenly grouping includes: grouping in a manner of computing-power-requirement-based even partitioning, or grouping in a manner of CSI-processing-unit-computing-power-based matching partitioning.

For example, an example of 6 precoding matrices being unevenly divided into 3 groups of the precoding matrices:

| | |
|---|---|
| Group 1 of the precoding matrices | precoding matrix 1 |
| Group 2 of the precoding matrices | precoding matrix 2 |
| Group 3 of the precoding matrices | precoding matrix 3, precoding |
| | matrix 4, precoding matrix 5, |
| | precoding matrix 6 |

For example, another example of 6 precoding matrices being unevenly divided into 3 groups of the precoding matrices:

| | |
|---|---|
| Group 1 of the precoding matrices | precoding matrix 1 |
| Group 2 of the precoding matrices | precoding matrix 2, precoding |
| | matrix 3 |
| Group 3 of the precoding matrices | precoding matrix 4, precoding |
| | matrix 5, precoding matrix 6 |

For example, an example of 6 precoding matrices being unevenly divided into 2 groups of the precoding matrices:

| | |
|---|---|
| Group 1 of the precoding matrices | precoding matrix 1 |
| Group 2 of the precoding matrices | precoding matrix 2, precoding |
| | matrix 3, precoding matrix 4, |
| | precoding matrix 5, precoding |
| | matrix 6 |

For example, another example of 6 precoding matrices being unevenly divided into 2 groups of the precoding matrices:

| | |
|---|---|
| Group 1 of the precoding matrices | precoding matrix 1, precoding |
| | matrix 2 |
| Group 2 of the precoding matrices | precoding matrix 3, precoding |
| | matrix 4, precoding matrix 5, |
| | precoding matrix 6 |

For example, an example of 7 precoding matrices being unevenly divided into 3 groups of the precoding matrices:

| | |
|---|---|
| Group 1 of the precoding matrices | precoding matrix 1 |
| Group 2 of the precoding matrices | precoding matrix 2 |
| Group 3 of the precoding matrices | precoding matrix 3, precoding |
| | matrix 4, precoding matrix 5, |
| | precoding matrix 6, precoding |
| | matrix 7 |

For example, another example of 7 precoding matrices being unevenly divided into 3 groups of the precoding matrices:

| | |
|---|---|
| Group 1 of the precoding matrices | precoding matrix 1 |
| Group 2 of the precoding matrices | precoding matrix 2, precoding |
| | matrix 3 |
| Group 3 of the precoding matrices | precoding matrix 4, precoding |
| | matrix 5, precoding matrix 6, |
| | precoding matrix 7 |

For example, another example of 7 precoding matrices being unevenly divided into 3 groups of the precoding matrices:

| | |
|---|---|
| Group 1 of the precoding matrices | precoding matrix 1, precoding |
| | matrix 2 |
| Group 2 of the precoding matrices | precoding matrix 3, precoding |
| | matrix 4 |
| Group 3 of the precoding matrices | precoding matrix 5, precoding |
| | matrix 6, precoding matrix 7 |

For example, an example of 7 precoding matrices being unevenly divided into 2 groups of the precoding matrices:

| | |
|---|---|
| Group 1 of the precoding matrices | precoding matrix 1 |
| Group 2 of the precoding matrices | precoding matrix 2, precoding |
| | matrix 3, precoding matrix 4, |
| | precoding matrix 5, precoding |
| | matrix 6, precoding matrix 7 |

For example, another example of 7 precoding matrices being unevenly divided into 2 groups of the precoding matrices:

| | |
|---|---|
| Group 1 of the precoding matrices | precoding matrix 1, precoding |
| | matrix 2 |
| Group 2 of the precoding matrices | precoding matrix 3, precoding |
| | matrix 4, precoding matrix 5, |
| | precoding matrix 6, precoding |
| | matrix 7 |

In the case where different precoding matrices correspond to different computing loads, i.e., different precoding matrices have different computing power requirements, M precoding matrices are divided into X groups in a manner of computing-power-requirement-based even partitioning, so that balance of the computing power requirement of each group of the precoding matrices can be realized, and then the load balance of each CSI calculation can be realized. In this implementation, in the case where 3 groups of the precoding matrices are divided into, the difference between the computing power requirements of the precoding matrices in group 1 of the precoding matrices, in group 2 of the precoding matrices and in group 3 of the precoding matrices does not exceed a preset difference degree or a preset difference threshold. In other words, the computing power requirements of the precoding matrices in each group of the precoding matrices are in balance. The computing power requirements of the precoding matrices on a group of the precoding matrices refer to a sum of the computing power requirement of each precoding matrix in the group of the precoding matrices.

In the case where the computing power of the CSI processing units responsible for each CSI calculation is not equal, M precoding matrices are unevenly divided into X groups, so that the matching between the computing power of the CSI processing units and the computing power requirements of the groups of the precoding matrices is realized, and then the processing efficiency of each CSI processing unit is improved. In this implementation, for example, in the case where 3 groups of the precoding matrices are divided into, the computing power requirements of the precoding matrices in the group 1 of the precoding matrices matches the computing power of the CSI processing unit 1, the computing power requirements of the precoding matrices in the group 2 of the precoding matrices matches the computing power of the CSI processing unit 2, and the computing power requirements of the precoding matrices in the group 3 of the precoding matrices matches the computing power of the CSI processing unit 3.

### Example 2.3

In the case where the configuration information includes the ranks of the precoding matrices or the groups of the ranks of the precoding matrices, the implementation process of S202 may include that the concurrent quantity is determined according to the quantity of the ranks of the precoding matrices or the quantity of the groups of the ranks of the precoding matrices.

Correspondingly, the implementation process of S203 may include that the first communication node determines the concurrent quantity according to the ranks of the precoding matrices, and concurrently calculates precoding matrices of M ranks according to the concurrent quantity.

One manner to determine the concurrent quantity O includes determining the quantity of the ranks of the precoding matrices as the concurrent quantity, that is, the concurrent quantity O is equal to the quantity of the ranks. For example, one CSI calculation corresponds to one rank, and M CSI calculations correspond to M ranks. In other words, the first communication node performs O CSI calculations at the same time, O is equal to the quantity M of ranks, and one CSI calculation corresponds to one rank.

Another manner to determine the concurrent quantity O includes determining the quantity of the groups of the ranks of the precoding matrices as the concurrent quantity, that is, the concurrent quantity O is equal to the quantity of the groups of the ranks. For example, M ranks are divided into X groups, and the concurrent quantity O is equal to X. One CSI calculation corresponds to one group of the ranks, and X CSI calculations correspond to X groups of the ranks. In other words, the first communication node performs O CSI calculations at the same time, O is equal to the quantity X of the groups of the ranks, and one CSI calculation corresponds to one group of the ranks.

The groups of the ranks of the precoding matrices includes each group of the ranks generated by grouping in a manner of quantity-based even partitioning, or each group of the ranks generated by grouping in a manner of computing-power-requirement-based even partitioning, or each group of the ranks generated by grouping in a manner of CSI-processing-unit-computing-power-based matching partitioning.

One manner of dividing M ranks into X groups includes that M ranks are almost evenly divided into X groups. For example, 6 ranks are divided into 2 groups, and each group of the ranks includes 3 ranks. For example, 6 ranks are divided into 3 groups, and each group of the ranks includes 2 ranks. For example, 7 ranks are divided into 2 groups, one group of the ranks includes 3 ranks and the other group of the ranks includes 4 ranks. For example, 7 ranks are divided into 3 groups, one group of the ranks includes 2 ranks, another group of the ranks includes 2 ranks, and another group of the ranks includes 3 ranks. M ranks are almost evenly divided into X groups, realizing the load balance of each CSI calculation. In other words, the load balance of each CSI processing unit can be realized, and the processing efficiency of CSI reports can be improved.

Another manner of dividing M ranks into X groups includes that M ranks are unevenly divided into X groups. The unevenly grouping includes: grouping in a manner of computing-power-requirement-based even partitioning, or grouping in a manner of CSI-processing-unit-computing-power-based matching partitioning.

For example, an example of 6 ranks being unevenly divided into 3 groups of the ranks:

| | |
|---|---|
| Group 1 of the ranks | rank 1 |
| Group 2 of the ranks | rank 2 |
| Group 3 of the ranks | rank 3, rank 4, rank 5, rank 6 |

For example, another example of 6 ranks being unevenly divided into 3 groups of the ranks:

| | |
|---|---|
| Group 1 of the ranks | rank 1 |
| Group 2 of the ranks | rank 2, rank 3 |
| Group 3 of the ranks | rank 4, rank 5, rank 6 |

For example, an example of 6 ranks being unevenly divided into 2 groups of the ranks:

| | |
|---|---|
| Group 1 of the ranks | rank 1 |
| Group 2 of the ranks | rank 2, rank 3, rank 4, |
| | rank 5, rank 6 |

For example, another example of 6 ranks being unevenly divided into 2 groups of the ranks:

| | |
|---|---|
| Group 1 of the ranks | rank 1, rank 2 |
| Group 2 of the ranks | rank 3, rank 4, rank 5, rank 6 |

For example, an example of 7 ranks being unevenly divided into 3 groups of the ranks:

| | |
|---|---|
| Group 1 of the ranks | rank 1 |
| Group 2 of the ranks | rank 2 |
| Group 3 of the ranks | rank 3, rank 4, rank 5, |
| | rank 6, rank 7 |

For example, another example of 7 ranks being unevenly divided into 3 groups of the ranks:

| | |
|---|---|
| Group 1 of the ranks | rank 1 |
| Group 2 of the ranks | rank 2, rank 3 |
| Group 3 of the ranks | rank 4, rank 5, rank 6, rank 7 |

For example, another example of 7 ranks being unevenly divided into 3 groups of the ranks:

| | |
|---|---|
| Group 1 of the ranks | rank 1, rank 2 |
| Group 2 of the ranks | rank 3, rank 4 |
| Group 3 of the ranks | rank 5, rank 6, rank 7 |

For example, an example of 7 ranks being unevenly divided into 2 groups of the ranks:

| | |
|---|---|
| Group 1 of the ranks | rank 1 |
| Group 2 of the ranks | rank 2, rank 3, rank 4, rank 5, |
| | rank 6, rank 7 |

For example, another example of 7 ranks being unevenly divided into 2 groups of the ranks:

| | |
|---|---|
| Group 1 of the ranks | rank 1, rank 2 |
| Group 2 of the ranks | rank 3, rank 4, rank 5, |
| | rank 6, rank 7 |

In the case where different ranks correspond to different computing loads, i.e., different ranks have different computing power requirements, M ranks are unevenly divided into X groups, so that the balance of the computing power requirement of each group of the ranks can be realized, and then the load balance of each CSI calculation can be realized. In this implementation, in the case where 3 groups of the ranks are divided into, the difference between the computing power requirements of the ranks in group 1 of the ranks, in group 2 of the ranks and in group 3 of the ranks does not exceed a preset difference degree or a preset difference threshold. In other words, the computing power requirements of the ranks in each group of the ranks are in balance. The computing power requirements of the ranks in a group of the ranks refer to a sum of the computing power requirement of each rank in the group of the ranks.

In the case where the computing power of the CSI processing units responsible for each CSI calculation is not equal, M ranks are divided into X groups in a manner of CSI-processing-unit-computing-power-based matching partitioning, so that the matching between the computing power of the CSI processing units and the computing power requirements of the group of the ranks is realized, and then the processing efficiency of each CSI processing unit is improved. In this implementation, for example, in the case where 3 groups of the ranks are divided into, the computing power requirements of the ranks in the group 1 of the ranks matches the computing power of the CSI processing unit 1, the computing power requirements of the ranks in the group 2 of the ranks matches the computing power of the CSI processing unit 2, and the computing power requirements of the ranks in the group 3 of the ranks matches the computing power of the CSI processing unit 3.

### Example 2.4

In the case where the configuration information includes layers of precoding matrices or groups of layers of precoding matrices, the implementation process of S202 includes determining the concurrent quantity according to the quantity of layers of precoding matrices or the quantity of the groups of layers of precoding matrices.

Correspondingly, the implementation process of S203 may include that the first communication node determines the concurrent quantity according to the layers of the precoding matrices, and concurrently calculates the precoding matrices of M layers according to the concurrent quantity.

One manner to determine the concurrent quantity O includes determining the quantity of the layers of the precoding matrices as the concurrent quantity, that is, the concurrent quantity O is equal to the quantity of the layers. For example, one CSI calculation corresponds to one layer, and M CSI calculations correspond to M layers. In other words, the first communication node performs O CSI calculations at the same time, O is equal to the quantity M of the layers, and one CSI calculation corresponds to one layer.

Another manner to determine the concurrent quantity O includes determining the quantity of the groups of the layers of the precoding matrices as the concurrent quantity, that is, the concurrent quantity O is equal to the quantity of the groups of the layers. For example, M layers are divided into X groups, and the concurrent quantity O is equal to X. One CSI calculation corresponds to one group of the layers, and X CSI calculations correspond to X groups of the layers. In other words, the first communication node performs O CSI calculations at the same time, O is equal to the quantity X of the groups of the layers, and one CSI calculation corresponds to one group of the layers.

The groups of the layers of the precoding matrices are generated by grouping in a manner of quantity-based even partitioning, or grouping in a manner of computing-power-requirement-based even partitioning, or grouping in a manner of CSI-processing-unit-computing-power-based matching partitioning.

One manner of dividing M layers into X groups includes that M layers are almost evenly divided into X groups. For example, 6 layers are divided into 2 groups, and each group of the layers includes 3 layers. For example, 6 layers are divided into 3 groups, and each group of the layers includes 2 layers. For example, 7 layers are divided into 2 groups, one group of the layers includes 3 layers, and the other group of the layers includes 4 layers. For example, 7 layers are divided into 3 groups, one group of the layers includes 2 layers, another group of the layers includes 2 layers, and another group of the layers includes 3 layers. M layers are almost evenly divided into X groups, realizing the load balance of each CSI calculation. In other words, the load balance of each CSI processing unit can be realized, and the processing efficiency of CSI reports can be improved.

Another manner of dividing M layers into X groups includes that M layers are unevenly divided into X groups. The unevenly grouping includes: grouping in a manner of computing-power-requirement-based even partitioning, or grouping in a manner of CSI-processing-unit-computing-power-based matching partitioning.

For example, an example of 6 layers being unevenly divided into 3 groups of the layers:

| | |
|---|---|
| Group 1 of the layers | layer 1 |
| Group 2 of the layers | layer 2 |
| Group 3 of the layers | layer 3, layer 4, layer 5, layer 6 |

For example, another example of 6 layers being unevenly divided into 3 groups of the layers:

| | |
|---|---|
| Group 1 of the layers | layer 1 |
| Group 2 of the layers | layer 2, layer 3 |
| Group 3 of the layers | layer 4, layer 5, layer 6 |

For example, an example of 6 layers being unevenly divided into 2 groups of the layers:

| | |
|---|---|
| Group 1 of the layers | layer 1 |
| Group 2 of the layers | layer 2, layer 3, layer 4, |
| | layer 5, layer 6 |

For example, another example of 6 layers being unevenly divided into 2 groups of the layers:

| | |
|---|---|
| Group 1 of the layers | layer 1, layer 2 |
| Group 2 of the layers | layer 3, layer 4, layer 5, layer 6 |

For example, an example of 7 layers being unevenly divided into 3 groups of the layers:

| | |
|---|---|
| Group 1 of the layers | layer 1 |
| Group 2 of the layers | layer 2 |
| Group 3 of the layers | layer 3, layer 4, layer 5, |
| | layer 6, layer 7 |

For example, another example of 7 layers being unevenly divided into 3 groups of the layers:

| | |
|---|---|
| Group 1 of the layers | layer 1 |
| Group 2 of the layers | layer 2, layer 3 |
| Group 3 of the layers | layer 4, layer 5, layer 6, layer 7 |

For example, another example of 7 layers being unevenly divided into 3 groups of the layers:

| | |
|---|---|
| Group 1 of the layers | layer 1, layer 2 |
| Group 2 of the layers | layer 3, layer 4 |
| Group 3 of the layers | layer 5, layer 6, layer 7 |

For example, an example of 7 layers being unevenly divided into 2 groups of the layers:

| | |
|---|---|
| Group 1 of the layers | layer 1 |
| Group 2 of the layers | layer 2, layer 3, layer 4, |
| | layer 5, layer 6, layer 7 |

For example, another example of 7 layers being unevenly divided into 2 groups of the layers:

| | |
|---|---|
| Group 1 of the layers | layer 1, layer 2 |
| Group 2 of the layers | layer 3, layer 4, layer 5, |
| | layer 6, layer 7 |

In the case where different layers correspond to different computing loads, i.e., different layers have different computing power requirements, M layers are unevenly divided into X groups to realize load balance of each CSI calculation, so that balance of the computing power requirement of each group of the layers can be realized, and then the load balance of each CSI calculation can be realized. In this implementation, in the case where 3 groups of the layers are divided into, the difference between the computing power requirements of the layers in group 1 of the layers, in group 2 of the layers and in group 3 of the layers does not exceed a preset difference degree or a preset difference threshold. In other words, the computing power requirements of the layers in each group of the layers are in balance. The computing power requirements of the layers in a group of the layers refer to a sum of the computing power requirement of each layer in the group of the layers.

In the case where the computing power of the CSI processing units responsible for each CSI calculation is not equal, M layers are divided into X groups in a manner of CSI-processing-unit-computing-power-based matching partitioning, so that the matching between the computing power of the CSI processing units and the computing power requirements of the groups of the layers is realized, and then the processing efficiency of each CSI processing unit is improved. In this implementation, for example, in the case where 3 groups of the layers are divided into, the computing power requirements of the layers in the group 1 of the layers matches the computing power of the CSI processing unit 1, the computing power requirements of the layers in the group 2 of the layers matches the computing power of the CSI processing unit 2, and the computing power requirements of the layers in the group 3 of the layers matches the computing power of the CSI processing unit 3.

### Example 2.5

In the case where the configuration information includes the codebooks of the precoding matrices or the groups of the codebooks of the precoding matrices, the implementation process of S202 includes determining the concurrent quantity according to the quantity of the codebooks of the precoding matrices or the quantity of the groups of the codebooks of the precoding matrices.

Correspondingly, the implementation process of S203 may include that the first communication node determines the concurrent quantity according to the codebooks of the precoding matrices, and concurrently calculates precoding matrices of M codebooks of precoding matrices according to the concurrent quantity.

One manner to determine the concurrent quantity O includes determining the quantity of the codebooks of the precoding matrices as the concurrent quantity, that is, the concurrent quantity O is equal to the quantity of the codebooks of the precoding matrices. For example, one CSI calculation corresponds to one precoding matrix codebook, and M CSI calculations correspond to M codebooks of precoding matrices. In other words, the first communication node performs O CSI calculations at the same time, O is equal to the quantity M of the codebooks of the precoding matrices, and one CSI calculation corresponds to one precoding matrix codebook.

Another manner to determine the concurrent quantity O includes determining the quantity of the groups of the codebooks of the precoding matrices as the concurrent quantity, that is, the concurrent quantity O is equal to the quantity of the groups of the codebooks of the precoding matrices For example, M codebooks of precoding matrices are divided into X groups, and the concurrent quantity O is equal to X. One CSI calculation corresponds to one group of codebooks of precoding matrices, and X CSI calculations correspond to X groups of the codebooks of the precoding matrices. In other words, the first communication node performs O CSI calculations at the same time, O is equal to the quantity X of the groups of the codebooks of the precoding matrices, and one CSI calculation corresponds to one group of codebooks of precoding matrices.

The groups of the codebooks of the precoding matrices include groups of codebooks of precoding matrices generated by grouping in a manner of quantity-based even partitioning, or grouping in a manner of computing-power-requirement-based even partitioning, or grouping in a manner of CSI-processing-unit-computing-power-based matching partitioning.

One manner of dividing M codebooks of precoding matrices into X groups includes that M codebooks of precoding matrices are almost evenly divided into X groups. For example, 6 codebooks of precoding matrices are divided into 2 groups, and each group of codebooks of precoding matrices includes 3 codebooks of precoding matrices. For example, 6 codebooks of precoding matrices are divided into 3 groups, and each group of codebooks of precoding matrices includes 2 codebooks of precoding matrices. For example, 7 codebooks of precoding matrices are divided into 2 groups, one group of codebooks of precoding matrices includes 3 codebooks of precoding matrices, and the other group of codebooks of precoding matrices includes 4 codebooks of precoding matrices. For example, 7 codebooks of precoding matrices are divided into 3 groups, one group of codebooks of precoding matrices includes 2 codebooks of precoding matrices, another group of codebooks of precoding matrices includes 2 codebooks of precoding matrices, and another group of codebooks of precoding matrices includes 3 codebooks of precoding matrices. M codebooks of precoding matrices are almost evenly divided into X groups, realizing the load balance of each CSI calculation. In other words, the load balance of each CSI processing unit can be realized, and the processing efficiency of CSI reports can be improved.

Another manner of dividing M codebooks of precoding matrices into X groups includes that M codebooks of precoding matrices are unevenly divided into X groups. The unevenly grouping includes: grouping in a manner of computing-power-requirement-based even partitioning, or grouping in a manner of CSI-processing-unit-computing-power-based matching partitioning.

For example, an example of 6 codebooks of precoding matrices being unevenly divided into 3 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2 |
| precoding matrices | |
| Group 3 of the codebooks of the | precoding matrix codebook 3, precoding |
| precoding matrices | matrix codebook 4, precoding matrix |
| | codebook 5, precoding matrix |
| | codebook 6 |

For example, another example of 6 codebooks of precoding matrices being unevenly divided into 3 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2, precoding |
| precoding matrices | matrix codebook 3 |
| Group 3 of the codebooks of the | precoding matrix codebook 4, precoding |
| precoding matrices | matrix codebook 5, precoding matrix |
| | codebook 6 |

For example, an example of 6 codebooks of precoding matrices being unevenly divided into 2 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2, precoding |
| precoding matrices | matrix codebook 3, precoding matrix |
| | codebook 4, precoding matrix codebook |
| | 5, precoding matrix codebook 6 |

For example, another example of 6 codebooks of precoding matrices being unevenly divided into 2 groups of the codebooks of the precoding matrices:

| | |
|---|---|
| Group 1 of the codebooks of the | precoding matrix codebook 1, precoding |
| precoding matrices | matrix codebook 2 |
| Group 2 of the codebooks of the | precoding matrix codebook 3, precoding |
| precoding matrices | matrix codebook 4, precoding matrix |
| | codebook 5, precoding matrix |
| | codebook 6 |

For example, an example of 7 codebooks of precoding matrices being unevenly divided into 3 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2 |
| precoding matrices | |
| Group 3 of the codebooks of the | precoding matrix codebook 3, precoding |
| precoding matrices | matrix codebook 4, precoding matrix |
| | codebook 5, precoding matrix codebook |
| | 6, precoding matrix codebook 7 |

For example, another example of 7 codebooks of precoding matrices being unevenly divided into 3 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2, precoding |
| precoding matrices | matrix codebook 3 |
| Group 3 of the codebooks of the | precoding matrix codebook 4, precoding |
| precoding matrices | matrix codebook 5, precoding matrix |
| | codebook 6, precoding matrix |
| | codebook 7 |

For example, another example of 7 codebooks of precoding matrices being unevenly divided into 3 groups of the codebooks of the precoding matrices:

| | |
|---|---|
| Group 1 of the codebooks of the | precoding matrix codebook 1, precoding |
| precoding matrices | matrix codebook 2 |
| Group 2 of the codebooks of the | precoding matrix codebook 3, precoding |
| precoding matrices | matrix codebook 4 |
| Group 3 of the codebooks of the | precoding matrix codebook 5, precoding |
| precoding matrices | matrix codebook 6, precoding matrix |
| | codebook 7 |

For example, an example of 7 codebooks of precoding matrices being unevenly divided into 2 groups of the codebooks of the precoding matrices:

| | |
|---|---|
| Group 1 of the codebooks of the | precoding matrix codebook 1 |
| precoding matrices | |
| Group 2 of the codebooks of the | precoding matrix codebook 2, precoding |
| precoding matrices | matrix codebook 3, precoding matrix |
| | codebook 4, precoding matrix codebook |
| | 5, precoding matrix codebook 6, |
| | precoding matrix codebook 7 |

For example, another example of 7 codebooks of precoding matrices being unevenly divided into 2 groups of the codebooks of the precoding matrices:

| | |
|---|---|
| Group 1 of the codebooks of the | precoding matrix codebook 1, precoding |
| precoding matrices | matrix codebook 2 |
| Group 2 of the codebooks of the | precoding matrix codebook 3, precoding |
| precoding matrices | matrix codebook 4, precoding matrix |
| | codebook 5, precoding matrix codebook |
| | 6, precoding matrix codebook 7 |

In the case where different codebooks of precoding matrices correspond to different computing loads, i.e., different codebooks of precoding matrices have different computing power requirements, M codebooks of precoding matrices are unevenly divided into X groups, so that balance of the computing power requirement of each group of codebooks of precoding matrices can be realized, and then the load balance of each CSI calculation can be realized. In this implementation, in the case where 3 groups of the codebooks of the precoding matrices are divided into, the difference between the computing power requirements of the codebooks of the precoding matrices in group 1 of the codebooks of the precoding matrices, in group 2 of the codebooks of the precoding matrices and in group 3 of the codebooks of the precoding matrices does not exceed a preset difference degree or a preset difference threshold. In other words, the computing power requirements of the codebooks of the precoding matrices in each group of codebooks of precoding matrices are in balance. The computing power requirements of the codebooks of the precoding matrices in the groups of the codebooks of the precoding matrices refer to a sum of the computing power requirement of each codebook of precoding matrices in the groups of the codebooks of the precoding matrices.

In the case where the computing power of the CSI processing units responsible for each CSI calculation is not equal, M codebooks of precoding matrices are unevenly divided into X groups, so that the matching between the computing power of the CSI processing units and the computing power requirements of the groups of the codebooks of the precoding matrices is realized, and then the processing efficiency of each CSI processing unit is improved. In this implementation, for example, in the case where 3 groups of the codebooks of the precoding matrices are divided into, the computing power requirements of the codebooks of the precoding matrices in the group 1 of the codebooks of the precoding matrices matches the computing power of the CSI processing unit 1, the computing power requirements of the codebooks of the precoding matrices in the group 2 of the codebooks of the precoding matrices matches the computing power of the CSI processing unit 2, and the computing power requirements of the codebooks of the precoding matrices in the group 3 of the codebooks of the precoding matrices matches the computing power of the CSI processing unit 3.

### Example 2.6

In the case where the configuration information includes machine learning models or groups of machine learning models, the implementation process of S202 includes determining the concurrent quantity according to the quantity of machine learning models or the quantity of the groups of machine learning models.

Correspondingly, the implementation process of S203 may include that the first communication node determines the concurrent quantity according to the machine learning models, and concurrently calculates precoding matrices of M machine learning models according to the concurrent quantity.

One manner to determine the concurrent quantity O includes determining the quantity of the machine learning models as the concurrent quantity, that is, the concurrent quantity O is equal to the quantity of the machine learning models. For example, one CSI calculation corresponds to one machine learning model, and M CSI calculations correspond to M machine learning models. In other words, the first communication node performs O CSI calculations at the same time, O is equal to the quantity M of the machine learning models, and one CSI calculation corresponds to one machine learning model.

Another manner to determine the concurrent quantity O includes determining the quantity of the groups of the machine learning models as the concurrent quantity, that is, the concurrent quantity O is equal to the quantity of the groups of the machine learning models. For example, M machine learning models are divided into X groups, and the concurrent quantity O is equal to X. One CSI calculation corresponds to one group of the machine learning models, and X CSI calculations correspond to X groups of the machine learning models. In other words, the first communication node performs O CSI calculations at the same time, O is equal to the quantity X of the groups of the machine learning models, and one CSI calculation corresponds to one group of the machine learning models.

The groups of the machine learning models include groups of the machine learning models generated by grouping in a manner of quantity-based even partitioning, or by grouping in a manner of computing-power-requirement-based even partitioning, or by grouping in a manner of CSI-processing-unit-computing-power-based matching partitioning.

One manner of dividing M machine learning models into X groups includes that M machine learning models are almost evenly divided into X groups. For example, 6 machine learning models are divided into 2 groups, and each group of the machine learning models includes 3 machine learning models. For example, 6 machine learning models are divided into 3 groups, and each group of the machine learning models includes 2 machine learning models. For example, 7 machine learning models are divided into 2 groups, one group of the machine learning models includes 3 machine learning models, and the other group of the machine learning models includes 4 machine learning models. For example, 7 machine learning models are divided into 3 groups, one group of the machine learning models includes 2 machine learning models, another group of the machine learning models includes 2 machine learning models, and another group of the machine learning models includes 3 machine learning models. M machine learning models are almost evenly divided into X groups, realizing the load balance of each CSI calculation.

Another manner of dividing M machine learning models into X groups includes that M machine learning models are unevenly divided into X groups. The unevenly grouping includes: grouping in a manner of computing-power-requirement-based even partitioning, or grouping in a manner of CSI-processing-unit-computing-power-based matching partitioning.

For example, an example of 6 machine learning models being unevenly divided into 3 groups of the machine learning models:

| | |
|---|---|
| Group 1 of the machine learning models | machine learning model 1 |
| Group 2 of the machine learning models | machine learning model 2 |
| Group 3 of the machine learning models | machine learning model 3, |
| | machine learning model 4, |
| | machine learning model 5, |
| | machine learning model 6 |

For example, another example of 6 machine learning models being unevenly divided into 3 groups of the machine learning models:

| | |
|---|---|
| Group 1 of the machine learning models | machine learning model 1 |
| Group 2 of the machine learning models | machine learning model 2, |
| | machine learning model 3 |
| Group 3 of the machine learning models | machine learning model 4, |
| | machine learning model 5, |
| | machine learning model 6 |

For example, an example of 6 machine learning models being unevenly divided into 2 groups of the machine learning models:

| | |
|---|---|
| Group 1 of the machine learning models | machine learning model 1 |
| Group 2 of the machine learning models | machine learning model 2, |
| | machine learning model 3, |
| | machine learning model 4, |
| | machine learning model 5, |
| | machine learning model 6 |

For example, another example of 6 machine learning models being unevenly divided into 2 groups of the machine learning models:

| | |
|---|---|
| Group 1 of the machine learning models | machine learning model 1, |
| | machine learning model 2 |
| Group 2 of the machine learning models | machine learning model 3, |
| | machine learning model 4, |
| | machine learning model 5, |
| | machine learning model 6 |

For example, an example of 7 machine learning models being unevenly divided into 3 groups of the machine learning models:

| | |
|---|---|
| Group 1 of the machine learning models | machine learning model 1 |
| Group 2 of the machine learning models | machine learning model 2 |
| Group 3 of the machine learning models | machine learning model 3, |
| | machine learning model 4, |
| | machine learning model 5, |
| | machine learning model 6, |
| | machine learning model 7 |

For example, another example of 7 machine learning models being unevenly divided into 3 groups of the machine learning models:

| | |
|---|---|
| Group 1 of the machine learning models | machine learning model 1 |
| Group 2 of the machine learning models | machine learning model 2, |
| | machine learning model 3 |
| Group 3 of the machine learning models | machine learning model 4, |
| | machine learning model 5, |
| | machine learning model 6, |
| | machine learning model 7 |

For example, another example of 7 machine learning models being unevenly divided into 3 groups of the machine learning models:

| | |
|---|---|
| Group 1 of the machine learning models | machine learning model 1 |
| Group 2 of the machine learning models | machine learning model 2, |
| | machine learning model 3 |
| Group 3 of the machine learning models | machine learning model 4, |
| | machine learning model 5, |
| | machine learning model 6, |
| | machine learning model 7 |

For example, an example of 7 machine learning models being unevenly divided into 2 groups of the machine learning models:

| | |
|---|---|
| Group 1 of the machine learning models | machine learning model 1 |
| Group 2 of the machine learning models | machine learning model 2, |
| | machine learning model 3, |
| | machine learning model 4, |
| | machine learning model 5, |
| | machine learning model 6, |
| | machine learning model 7 |

For example, another example of 7 machine learning models being unevenly divided into 2 groups of the machine learning models:

| | |
|---|---|
| Group 1 of the machine learning models | machine learning model 1, |
| | machine learning model 2 |
| Group 2 of the machine learning models | machine learning model 3, |
| | machine learning model 4, |
| | machine learning model 5, |
| | machine learning model 6, |
| | machine learning model 7 |

In the case where different machine learning models correspond to different computing loads, i.e., different machine learning models have different computing power requirements, M machine learning models are unevenly divided into X groups, so that balance of the computing power requirement of each group of the machine learning models can be realized, and then the load balance of each CSI calculation can be realized. In this implementation, in the case where 3 groups of the machine learning models are divided into, the difference between the computing power requirements of the machine learning models in group 1 of the machine learning models, in group 2 of the machine learning models and in group 3 of the machine learning models does not exceed a preset difference degree or a preset difference threshold. In other words, the computing power requirements of the machine learning models in each group of the machine learning models are in balance. The computing power requirements of the machine learning models in the groups of the machine learning models refer to a sum of the computing power requirement of each machine learning model in the groups of the machine learning models.

In the case where the computing power of the CSI processing units responsible for each CSI calculation is not equal, M machine learning models are unevenly divided into X groups, so that the matching between the computing power of the CSI processing units and the computing power requirements of the groups of the machine learning models is realized, and then the processing efficiency of each CSI processing unit is improved. In this implementation, for example, in the case where 3 groups of the machine learning models are divided into, the computing power requirements of the machine learning models in the group 1 of the machine learning models matches the computing power of the CSI processing unit 1, the computing power requirements of the machine learning models in the group 2 of the machine learning models matches the computing power of the CSI processing unit 2, and the computing power requirements of the machine learning models in the group 3 of the machine learning models matches the computing power of the CSI processing unit 3.

### Example 2.7

In the case where the configuration information includes the overheads of the precoding matrices or the groups of the overheads of the precoding matrices, the implementation process of S202 includes determining the concurrent quantity according to the quantity of overheads of precoding matrices or the quantity of groups of overheads of precoding matrices. The overheads of the precoding matrices in the present embodiment may also be simply referred to as overheads.

Correspondingly, the implementation process of S203 may include that the first communication node determines the concurrent quantity according to the overheads of the precoding matrices, and concurrently calculates precoding matrices of M overheads according to the concurrent quantity.

One manner to determine the concurrent quantity O includes determining the quantity of the overheads as the concurrent quantity, that is, the concurrent quantity O is equal to the quantity of the overheads. For example, one CSI calculation corresponds to one overhead, and M CSI calculations correspond to M overheads. In other words, the first communication node performs O CSI calculations at the same time, O is equal to the quantity M of the overheads, and one CSI calculation corresponds to one overhead.

Another manner to determine the concurrent quantity O includes determining the quantity of the groups of the overheads as the concurrent quantity, that is, the concurrent quantity O is equal to the quantity of the groups of the overheads. For example, M overheads is divided into X groups, and the concurrent quantity O is equal to X. One CSI calculation corresponds to one group of the overheads, and X CSI calculations correspond to X groups of the overheads. In other words, the first communication node performs O CSI calculations at the same time, O is equal to the quantity X of the groups of the overheads, and one CSI calculation corresponds to one group of the overheads.

The groups of the overheads include groups of the overheads generated by grouping in a manner of quantity-based even partitioning, or by grouping in a manner of computing-power-requirement-based even partitioning, or by grouping in a manner of CSI-processing-unit-computing-power-based matching partitioning.

One manner of dividing M overheads into X groups includes that M overheads are almost evenly divided into X groups. For example, 6 overheads are divided into 2 groups, and each group of the overheads includes 3 overheads. For example, 6 overheads are divided into 3 groups, and each group of the overheads includes 2 overheads. For example, 7 overheads are divided into 2 groups, one group of the overheads includes 3 overheads, and the other group of the overheads includes 4 overheads. For example, 7 overheads are divided into 3 groups, one group of the overheads includes 2 overheads, another group of the overheads includes 2 overheads, and another group of the overheads includes 3 overheads. M overheads are almost evenly divided into X groups, realizing the load balance of each CSI calculation.

Another manner of dividing M overheads into X groups includes that M overheads are unevenly divided into X groups. The unevenly grouping includes: grouping in a manner of computing-power-requirement-based even partitioning, or grouping in a manner of CSI-processing-unit-computing-power-based matching partitioning.

For example, an example of 6 overheads being unevenly divided into 3 groups of the overheads:

| | |
|---|---|
| Group 1 of the overheads | overhead 1 |
| Group 2 of the overheads | overhead 2 |
| Group 3 of the overheads | overhead 3, overhead 4, |
| | overhead 5, overhead 6 |

For example, another example of 6 overheads being unevenly divided into 3 groups of the overheads:

| | |
|---|---|
| Group 1 of the overheads | overhead 1 |
| Group 2 of the overheads | overhead 2, overhead 3 |
| Group 3 of the overheads | overhead 4, overhead 5, |
| | overhead 6 |

For example, an example of 6 overheads being unevenly divided into 2 groups of the overheads:

| | |
|---|---|
| Group 1 of the overheads | overhead 1 |
| Group 2 of the overheads | overhead 2, overhead 3, |
| | overhead 4, overhead 5, |
| | overhead 6 |

For example, another example of 6 overheads being unevenly divided into 2 groups of the overheads:

| | |
|---|---|
| Group 1 of the overheads | overhead 1, overhead 2 |
| Group 2 of the overheads | overhead 3, overhead 4, |
| | overhead 5, overhead 6 |

For example, an example of 7 overheads being unevenly divided into 3 groups of the overheads:

| | |
|---|---|
| Group 1 of the overheads | overhead 1 |
| Group 2 of the overheads | overhead 2 |
| Group 3 of the overheads | overhead 3, overhead 4, |
| | overhead 5, overhead 6, |
| | overhead 7 |

For example, another example of 7 overheads being unevenly divided into 3 groups of the overheads:

| | |
|---|---|
| Group 1 of the overheads | overhead 1 |
| Group 2 of the overheads | overhead 2, overhead 3 |
| Group 3 of the overheads | overhead 4, overhead 5, |
| | overhead 6, overhead 7 |

For example, another example of 7 overheads being unevenly divided into 3 groups of the overheads:

| | |
|---|---|
| Group 1 of the overheads | overhead 1, overhead 2 |
| Group 2 of the overheads | overhead 3, overhead 4 |
| Group 3 of the overheads | overhead 5, overhead 6, |
| | overhead 7 |

For example, an example of 7 overheads being unevenly divided into 2 groups of the overheads:

| | |
|---|---|
| Group 1 of the overheads | overhead 1 |
| Group 2 of the overheads | overhead 2, overhead 3, |
| | overhead 4, overhead 5, |
| | overhead 6, overhead 7 |

For example, another example of 7 overheads being unevenly divided into 2 groups of the overheads:

| | |
|---|---|
| Group 1 of the overheads | overhead 1, overhead 2 |
| Group 2 of the overheads | overhead 3, overhead 4, |
| | overhead 5, overhead 6, |
| | overhead 7 |

In the case where different overheads correspond to different computing loads, i.e., different overheads have different computing power requirements, M overheads are unevenly divided into X groups, so that the balance of the computing power requirement of each group of the overheads can be realized, and then the load balance of each CSI calculation can be realized. In this implementation, in the case where 3 groups of the overheads are divided into, the difference between the computing power requirements of the overheads in group 1 of the overheads, in group 2 of the overheads and in group 3 of the overheads does not exceed a preset difference degree or a preset difference threshold. In other words, the computing power requirements of the overheads in each group of the overheads are in balance. The computing power requirements of the overheads in a group of the overheads refer to a sum of the computing power requirement of each overhead in the group of the overheads.

In the case where the computing power of the CSI processing units responsible for each CSI calculation is not equal, M overheads are unevenly divided into X groups, so that the matching between the computing power of the CSI processing units and the computing power requirements of the groups of the overheads is realized, and then the processing efficiency of each CSI processing unit is improved. In this implementation, for example, in the case where 3 groups of the overheads are divided into, the computing power requirements of the overheads in the group 1 of the overheads matches the computing power of the CSI processing unit 1, the computing power requirements of the overheads in the group 2 of the overheads matches the computing power of the CSI processing unit 2, and the computing power requirements of the overheads in the group 3 of the overheads matches the computing power of the CSI processing unit 3.

### Example 2.8

In the case where the configuration information includes frequency domain units or groups of frequency domain units, the implementation process of S202 includes determining the concurrent quantity according to the quantity of frequency domain units or the quantity of the groups of frequency domain units.

Correspondingly, the implementation process of S203 may include that the first communication node determines the concurrent quantity according to the frequency domain units, and concurrently calculates the precoding matrices of M frequency domain units according to the concurrent quantity.

One manner to determine the concurrent quantity O includes determining the quantity of the frequency domain units as the concurrent quantity, that is, the concurrent quantity O is equal to the quantity of the frequency domain units. For example, one CSI calculation corresponds to one frequency domain unit, and M CSI calculations correspond to M frequency domain units. In other words, the first communication node performs O CSI calculations at the same time, O is equal to the quantity M of the frequency domain units, and one CSI calculation corresponds to one frequency domain unit.

Another manner to determine the concurrent quantity O includes determining the quantity of the groups of the frequency domain units as the concurrent quantity, that is, the concurrent quantity O is equal to the quantity of the groups of the frequency domain units. For example, M frequency domain units are divided into X groups, and the concurrent quantity O is equal to X. One CSI calculation corresponds to one group of the frequency domain units, and X CSI calculations correspond to X groups of the frequency domain units. In other words, the first communication node performs O CSI calculations at the same time, O is equal to the quantity X of the groups of the frequency domain units, and one CSI calculation corresponds to one group of the frequency domain units.

The groups of the frequency domain units include groups of the frequency domain units generated by grouping in a manner of quantity-based even partitioning, or by grouping in a manner of computing-power-requirement-based even partitioning, or by grouping in a manner of CSI-processing-unit-computing-power-based matching partitioning.

One manner of dividing M frequency domain units into X groups includes that M frequency domain units are almost evenly divided into X groups. For example, 6 frequency domain units are divided into 2 groups, and each group of the frequency domain units includes 3 frequency domain units. For example, 6 frequency domain units are divided into 3 groups, and each group of the frequency domain units includes 2 frequency domain units. For example, 7 frequency domain units are divided into 2 groups, one group of the frequency domain units includes 3 frequency domain units and the other group of the frequency domain units includes 4 frequency domain units. For example, 7 frequency domain units are divided into 3 groups, one group of the frequency domain units includes 2 frequency domain units, another group of the frequency domain units includes 2 frequency domain units, and another group of the frequency domain units includes 3 frequency domain units. M frequency domain units are almost evenly divided into X groups, realizing the load balance of each CSI calculation.

Another manner of dividing M frequency domain units into X groups includes that M frequency domain units are unevenly divided into X groups. The unevenly grouping includes: grouping in a manner of computing-power-requirement-based even partitioning, or grouping in a manner of CSI-processing-unit-computing-power-based matching partitioning.

For example, an example of 6 frequency domain units being unevenly divided into 3 groups of the frequency domain units:

| | |
|---|---|
| Group 1 of the frequency domain units | frequency domain unit 1 |
| Group 2 of the frequency domain units | frequency domain unit 2 |
| Group 3 of the frequency domain units | frequency domain unit 3, |
| | frequency domain unit 4, |
| | frequency domain unit 5, |
| | frequency domain unit 6 |

For example, another example of 6 frequency domain units being unevenly divided into 3 groups of the frequency domain units:

| | |
|---|---|
| Ggroup 1 of the frequency domain units | frequency domain unit 1 |
| Group 2 of the frequency domain units | frequency domain unit 2, |
| | frequency domain unit 3 |
| Group 3 of the frequency domain units | frequency domain unit 4, |
| | frequency domain unit 5, |
| | frequency domain unit 6 |

For example, an example of 6 frequency domain units being unevenly divided into 2 groups of the frequency domain units:

| | |
|---|---|
| Group 1 of the frequency domain units | frequency domain unit 1 |
| Group 2 of the frequency domain units | frequency domain unit 2, |
| | frequency domain unit 3, |
| | frequency domain unit 4, |
| | frequency domain unit 5, |
| | frequency domain unit 6 |

For example, another example of 6 frequency domain units being unevenly divided into 2 groups of the frequency domain units:

| | |
|---|---|
| Group 1 of the frequency domain units | frequency domain unit 1, |
| | frequency domain unit 2 |
| Group 2 of the frequency domain units | frequency domain unit 3, |
| | frequency domain unit 4, |
| | frequency domain unit 5, |
| | frequency domain unit 6 |

For example, an example of 7 frequency domain units being unevenly divided into 3 groups of the frequency domain units:

| | |
|---|---|
| Group 1 of the frequency domain units | frequency domain unit 1 |
| Group 2 of the frequency domain units | frequency domain unit 2 |
| Group 3 of the frequency domain units | frequency domain unit 3, |
| | frequency domain unit 4, |
| | frequency domain unit 5, |
| | frequency domain unit 6, |
| | frequency domain unit 7 |

For example, another example of 7 frequency domain units being unevenly divided into 3 groups of the frequency domain units:

| | |
|---|---|
| Group 1 of the frequency domain units | frequency domain unit 1 |
| Group 2 of the frequency domain units | frequency domain unit 2, |
| | frequency domain unit 3 |
| Group 3 of the frequency domain units | frequency domain unit 4, |
| | frequency domain unit 5, |
| | frequency domain unit 6, |
| | frequency domain unit 7 |

For example, another example of 7 frequency domain units being unevenly divided into 3 groups of the frequency domain units:

| | |
|---|---|
| Group 1 of the frequency domain units | frequency domain unit 1, |
| | frequency domain unit 2 |
| Group 2 of the frequency domain units | frequency domain unit 3, |
| | frequency domain unit 4 |
| Group 3 of the frequency domain units | frequency domain unit 5, |
| | frequency domain unit 6, |
| | frequency domain unit 7 |

For example, an example of 7 frequency domain units being unevenly divided into 2 groups of the frequency domain units:

| | |
|---|---|
| Group 1 of the frequency domain units | frequency domain unit 1 |
| Group 2 of the frequency domain units | frequency domain unit 2, |
| | frequency domain unit 3, |
| | frequency domain unit 4, |
| | frequency domain unit 5, |
| | frequency domain unit 6, |
| | frequency domain unit 7 |

For example, another example of 7 frequency domain units being unevenly divided into 2 groups of the frequency domain units:

| | |
|---|---|
| Group 1 of the frequency domain units | frequency domain unit 1, |
| | frequency domain unit 2 |
| Group 2 of the frequency domain units | frequency domain unit 3, |
| | frequency domain unit 4, |
| | frequency domain unit 5, |
| | frequency domain unit 6, |
| | frequency domain unit 7 |

In the case where different frequency domain units correspond to different computing loads, i.e., different frequency domain units have different computing power requirements, M frequency domain units are unevenly divided into X groups, so that balance of the computing power requirement of each group of the frequency domain units can be realized, and then the load balance of each CSI calculation can be realized. In this implementation, in the case where 3 groups of the frequency domain units are divided into, the difference between the computing power requirements of the frequency domain units in group 1 of the frequency domain units, in group 2 of the frequency domain units and in group 3 of the frequency domain units does not exceed a preset difference degree or a preset difference threshold. In other words, the computing power requirements of the frequency domain units in each group of the frequency domain units are in balance. The computing power requirements of the frequency domain units in a group of the frequency domain units refer to a sum of the computing power requirements of frequency domain units in the group of the frequency domain units.

In the case where the computing power of the CSI processing units responsible for each CSI calculation is not equal, M frequency domain units are unevenly divided into X groups, so that the matching between the computing power of the CSI processing units and the computing power requirements of the groups of the frequency domain units is realized, and then the processing efficiency of each CSI processing unit is improved. In this implementation, for example, in the case where 3 groups of the frequency domain units are divided into, the computing power requirements of the frequency domain units in the group 1 of the frequency domain units matches the computing power of the CSI processing unit 1, the computing power requirements of the frequency domain units in the group 2 of the frequency domain units matches the computing power of the CSI processing unit 2, and the computing power requirements of the frequency domain units in the group 3 of the frequency domain units matches the computing power of the CSI processing unit 3.

### Example 2.9

In the case where the configuration information includes the precoding matrix acquisition schemes or the groups of the precoding matrix acquisition schemes, the implementation process of S202 includes determining the concurrent quantity according to the quantity of the precoding matrix acquisition schemes or the quantity of the groups of the precoding matrix acquisition schemes.

Correspondingly, the implementation process of S203 may include that the first communication node determines the concurrent quantity according to the precoding matrix acquisition schemes, and concurrently calculates precoding matrices of M precoding matrix acquisition schemes according to the concurrent quantity.

One manner to determine the concurrent quantity O includes determining the quantity of the precoding matrix acquisition schemes as the concurrent quantity, that is, the concurrent quantity O is equal to the quantity of the precoding matrix acquisition schemes. For example, one CSI calculation corresponds to one precoding matrix acquisition scheme, and M CSI calculations correspond to M precoding matrix acquisition schemes. In other words, the first communication node performs O CSI calculations at the same time, O is equal to the quantity M of the precoding matrix acquisition schemes, and one CSI calculation corresponds to one precoding matrix acquisition scheme.

Another manner to determine the concurrent quantity O includes determining the quantity of the groups of the precoding matrix acquisition schemes as the concurrent quantity, that is, the concurrent quantity O is equal to the quantity of the groups of the precoding matrix acquisition schemes. For example, M precoding matrix acquisition schemes are divided into X groups, and the concurrent quantity O is equal to X. One CSI calculation corresponds to one group of precoding matrix acquisition schemes, and X CSI calculations correspond to X groups of the precoding matrix acquisition schemes. In other words, the first communication node performs O CSI calculations at the same time, O is equal to the quantity X of the groups of the precoding matrix acquisition schemes, and one CSI calculation corresponds to one group of precoding matrix acquisition schemes.

The groups of the precoding matrix acquisition schemes include groups of precoding matrix acquisition schemes generated by grouping in a manner of quantity-based even partitioning, or by grouping in a manner of computing-power-requirement-based even partitioning, or by grouping in a manner of CSI-processing-unit-computing-power-based matching partitioning.

One manner of dividing M precoding matrix acquisition schemes into X groups includes that M precoding matrix acquisition schemes are almost evenly divided into X groups. For example, 6 precoding matrix acquisition schemes are divided into 2 groups, and each group of precoding matrix acquisition schemes includes 3 precoding matrix acquisition schemes. For example, 6 precoding matrix acquisition schemes are divided into 3 groups, and each group of precoding matrix acquisition schemes includes 2 precoding matrix acquisition schemes. For example, 7 precoding matrix acquisition schemes are divided into 2 groups, one group of precoding matrix acquisition schemes includes 3 precoding matrix acquisition schemes, and the other group of precoding matrix acquisition schemes includes 4 precoding matrix acquisition schemes. For example, 7 precoding matrix acquisition schemes are divided into 3 groups, one group of precoding matrix acquisition schemes includes 2 precoding matrix acquisition schemes, another group of precoding matrix acquisition schemes includes 2 precoding matrix acquisition schemes, and another group of precoding matrix acquisition schemes includes 3 precoding matrix acquisition schemes. M precoding matrix acquisition schemes are almost evenly divided into X groups, realizing the load balance of each CSI calculation.

Another manner of dividing M precoding matrix acquisition schemes into X groups includes that M precoding matrix acquisition schemes are unevenly divided into X groups. The unevenly grouping includes: grouping in a manner of computing-power-requirement-based even partitioning, or grouping in a manner of CSI-processing-unit-computing-power-based matching partitioning.

For example, an example of 6 precoding matrix acquisition schemes being unevenly divided into 3 groups of the precoding matrix acquisition schemes:

| | |
|---|---|
| Group 1 of the precoding | precoding matrix acquisition scheme 1 |
| matrix acquisition schemes | |
| Group 2 of the precoding | precoding matrix acquisition scheme 2 |
| matrix acquisition schemes | |
| Group 3 of the precoding | precoding matrix acquisition scheme 3, |
| matrix acquisition schemes | precoding matrix acquisition scheme 4, |
| | precoding matrix acquisition scheme 5, |
| | precoding matrix acquisition scheme 6 |

For example, another example of 6 precoding matrix acquisition schemes being unevenly divided into 3 groups of the precoding matrix acquisition schemes:

| | |
|---|---|
| Group 1 of the precoding | precoding matrix acquisition scheme 1 |
| matrix acquisition schemes | |
| Group 2 of the precoding | precoding matrix acquisition scheme 2, |
| matrix acquisition schemes | precoding matrix acquisition scheme 3 |
| Group 3 of the precoding | precoding matrix acquisition scheme 4, |
| matrix acquisition schemes | precoding matrix acquisition scheme 5, |
| | precoding matrix acquisition scheme 6 |

For example, an example of 6 precoding matrix acquisition schemes being unevenly divided into 2 groups of the precoding matrix acquisition schemes:

| | |
|---|---|
| Group 1 of the precoding | precoding matrix acquisition scheme 1 |
| matrix acquisition schemes | |
| Group 2 of the precoding | precoding matrix acquisition scheme 2, |
| matrix acquisition schemes | precoding matrix acquisition scheme 3, |
| | precoding matrix acquisition scheme 4, |
| | precoding matrix acquisition scheme 5, |
| | precoding matrix acquisition scheme 6 |

For example, another example of 6 precoding matrix acquisition schemes being unevenly divided into 2 groups of the precoding matrix acquisition schemes:

| | |
|---|---|
| Group 1 of the precoding | precoding matrix acquisition scheme 1, |
| matrix acquisition schemes | precoding matrix acquisition scheme 2 |
| Group 2 of the precoding | precoding matrix acquisition scheme 3, |
| matrix acquisition schemes | precoding matrix acquisition scheme 4, |
| | precoding matrix acquisition scheme 5, |
| | precoding matrix acquisition scheme 6 |

For example, an example of 7 precoding matrix acquisition schemes being unevenly divided into 3 groups of the precoding matrix acquisition schemes:

matrix

| | |
|---|---|
| Group 1 of the precoding | precoding matrix acquisition scheme 1 |
| matrix acquisition schemes | |
| Group 2 of the precoding | precoding matrix acquisition scheme 2 |
| matrix acquisition schemes | |
| Group 3 of the precoding | precoding matrix acquisition scheme 3, |
| matrix acquisition schemes | precoding matrix acquisition scheme 4, |
| | precoding matrix acquisition scheme 5, |
| | precoding matrix acquisition scheme 6 |

For example, another example of 7 precoding matrix acquisition schemes being unevenly divided into 3 groups of the precoding matrix acquisition schemes:

| | |
|---|---|
| Group 1 of the precoding | precoding matrix acquisition scheme 1 |
| matrix acquisition schemes | |
| Group 2 of the precoding | precoding matrix acquisition scheme 2, |
| matrix acquisition schemes | precoding matrix acquisition scheme 3 |
| Group 3 of the precoding | precoding matrix acquisition scheme 4, |
| matrix acquisition schemes | precoding matrix acquisition scheme 5, |
| | precoding matrix acquisition scheme 6, |
| | precoding matrix acquisition scheme 7 |

For example, another example of 7 precoding matrix acquisition schemes being unevenly divided into 3 groups of the precoding matrix acquisition schemes:

| | |
|---|---|
| Group 1 of the precoding | precoding matrix acquisition scheme 1, |
| matrix acquisition schemes | precoding matrix acquisition scheme 2 |
| Group 2 of the precoding | precoding matrix acquisition scheme 3, |
| matrix acquisition schemes | precoding matrix acquisition scheme 4 |
| Group 3 of the precoding | precoding matrix acquisition scheme 5, |
| matrix acquisition schemes | precoding matrix acquisition scheme 6, |
| | precoding matrix acquisition scheme 7 |

For example, an example of 7 precoding matrix acquisition schemes being unevenly divided into 2 groups of the precoding matrix acquisition schemes:

| | |
|---|---|
| Group 1 of the precoding | precoding matrix acquisition scheme 1 |
| matrix acquisition schemes | |
| Group 2 of the precoding | precoding matrix acquisition scheme 2, |
| matrix acquisition schemes | precoding matrix acquisition scheme 3, |
| | precoding matrix acquisition scheme 4, |
| | precoding matrix acquisition scheme 5, |
| | precoding matrix acquisition scheme 6, |
| | precoding matrix acquisition scheme 7 |

For example, another example of 7 precoding matrix acquisition schemes being unevenly divided into 2 groups of the precoding matrix acquisition schemes:

| | |
|---|---|
| Group 1 of the precoding | precoding matrix acquisition scheme 1, |
| matrix acquisition schemes | precoding matrix acquisition scheme 2 |
| Group 2 of the precoding | precoding matrix acquisition scheme 3, |
| matrix acquisition schemes | precoding matrix acquisition scheme 4, |
| | precoding matrix acquisition scheme 5, |
| | precoding matrix acquisition scheme 6, |
| | precoding matrix acquisition scheme 7 |

In the case where different precoding matrix acquisition schemes correspond to different computing loads, i.e., different precoding matrix acquisition schemes have different computing power requirements, M precoding matrix acquisition schemes are unevenly divided into X groups, so that balance of the computing power requirement of each group of precoding matrix acquisition schemes can be realized, and then the load balance of each CSI calculation can be realized. In this implementation, in the case where 3 groups of the precoding matrix acquisition schemes are divided into, the difference between the computing power requirements of the precoding matrix acquisition schemes in group 1 of the precoding matrix acquisition schemes, in group 2 of the precoding matrix acquisition schemes and in group 3 of the precoding matrix acquisition schemes does not exceed a preset difference degree or a preset difference threshold. In other words, the computing power requirements of the precoding matrix acquisition schemes in each group of precoding matrix acquisition schemes are in balance. The computing power requirements of the precoding matrix acquisition schemes in the groups of the precoding matrix acquisition schemes refer to a sum of the computing power requirements of precoding matrix acquisition schemes in the groups of the precoding matrix acquisition schemes.

In the case where the computing power of the CSI processing units responsible for each CSI calculation is not equal, M precoding matrix acquisition schemes are unevenly divided into X groups, so that the matching between the computing power of the CSI processing units and the computing power requirements of the groups of the precoding matrix acquisition schemes is realized, and then the processing efficiency of each CSI processing unit is improved. In this implementation, for example, in the case where 3 groups of the precoding matrix acquisition schemes are divided into, the computing power requirements of the precoding matrix acquisition schemes in the group 1 of the precoding matrix acquisition schemes matches the computing power of the CSI processing unit 1, the computing power requirements of the precoding matrix acquisition schemes in the group 2 of the precoding matrix acquisition schemes matches the computing power of the CSI processing unit 2, and the computing power requirements of the precoding matrix acquisition schemes in the group 3 of the precoding matrix acquisition schemes matches the computing power of the CSI processing unit 3.

In the above examples 2.3 to 2.9, for ease of description, any one of the codebooks of the precoding matrices, the groups of the codebooks of the precoding matrices, the ranks of the precoding matrices, the groups of the ranks of the precoding matrices, the layers of the precoding matrices, the groups of the layers of the precoding matrices, the overheads of the precoding matrices, the groups of the overheads of the precoding matrices, the machine learning models, the groups of the machine learning models, the frequency domain units, the groups of the frequency domain units, the precoding matrix acquisition schemes and the groups of the precoding matrix acquisition schemes is referred to as target data, and the concurrency quantity is determined according to the quantity of pieces of the target data. In addition to determining the quantity of pieces of the target data as the concurrent quantity as described in the above example, a processed quantity of pieces of the target data may also be determined as the concurrent quantity in the present embodiment. The processed quantity may be obtained by performing data processing on the quantity based on at least one of the four arithmetic operations with a preset value. Alternatively, the quantity of pieces of the target data is compared with a certain preset value, and the greater or smaller one of the quantity of pieces of the target data and the certain preset value is determined as the concurrent quantity. The preset value here may be an integer greater than 0.

### Example 2.10

The implementation process of S202 may include determining the quantity of the CSI-RS resources in the CSI-RS resource set corresponding to the CSI reports and the purpose of the precoding matrices in the CSI reports according to the configuration information, and determining the concurrent quantity according to the quantity of the CSI-RS resources in the CSI-RS resource set corresponding to the CSI reports and the purpose of the precoding matrices in the CSI reports.

The first communication node may determine the purpose of the precoding matrices in the CSI reports according to the information for monitoring precoding matrix acquisition schemes, or determine the purpose of the precoding matrices according to the overheads of the precoding matrices. The first communication node may determine the quantity of the CSI-RS resources in the CSI-RS resource set corresponding to the CSI reports according to the information of the CSI-RS resources.

The implementation of determining the concurrent quantity according to the quantity of the CSI-RS resources in the CSI-RS resource set corresponding to the CSI reports and the purpose of the precoding matrices in the CSI reports may include determining rules corresponding to the purpose of the precoding matrices in the CSI reports and determining the concurrent quantity according to the rules corresponding to the purpose of the precoding matrices in the CSI reports and the quantity of the CSI-RS resources in the CSI-RS resource set corresponding to the CSI reports.

The rule corresponding to the purpose of the precoding matrices in the CSI reports may include that the processed quantity of the CSI-RS resources is determined as the concurrent quantity. The processed quantity here may be obtained by performing data on the quantity based on at least one of the four arithmetic operations with the preset value. Alternatively, the quantity of the CSI-RS resources is compared with a certain preset value, and the greater or smaller one of the quantity of the CSI-RS resources and the certain preset value is determined as the concurrent quantity. Alternatively, the quantity of the CSI-RS resources is determined as the concurrent quantity. The preset value here may be an integer greater than 0.

For example, the purpose corresponding to the precoding matrices in the CSI reports includes monitoring schemes for CSI calculations, and the concurrent quantity O for the CSI calculations is twice the quantity of the CSI-RS resources. For another example, the purpose corresponding to the precoding matrices in the CSI reports includes monitoring schemes for CSI calculations, and the concurrent quantity O for the CSI calculations is a sum of the quantity of the CSI-RS resources and 1, or the concurrent quantity O for the CSI calculations is equal to the quantity of the CSI-RS resources plus 1. For another example, the purpose corresponding to the precoding matrices in the CSI reports includes monitoring schemes for CSI calculations, and the concurrent quantity O for the CSI calculations is equal to the greater one of the quantity of the CSI-RS resources and 2. For another example, the purpose corresponding to the precoding matrices in the CSI reports includes monitoring schemes for CSI calculations, the concurrent quantity of the first-type CSI processing units for CSI calculations is equal to the quantity of the CSI-RS resources, and the concurrent quantity of the second-type CSI processing units for CSI calculations is equal to the quantity of the CSI-RS resources. In other words, the quantity of the first-type CSI processing units occupied is equal to the quantity of the CSI-RS resources, and the quantity of the second-type CSI processing units occupied is equal to the quantity of the CSI-RS resources. For another example, the purpose corresponding to the precoding matrices in the CSI reports includes monitoring schemes for CSI calculations, the concurrent quantity of the first-type CSI processing units for CSI calculations is equal to the quantity of the CSI-RS resources, and the concurrent quantity of the second-type CSI processing units for CSI calculations is equal to 1. In other words, the quantity of the first-type CSI processing units occupied is equal to the quantity of the CSI-RS resources, and the quantity of the second-type CSI processing units occupied is equal to 1. For another example, the purpose corresponding to the precoding matrices in the CSI reports includes monitoring schemes for CSI calculations, the concurrent quantity of the first-type CSI processing units for CSI calculations is equal to the quantity of the CSI-RS resources, and the concurrent quantity of the second-type CSI processing units for CSI calculations is equal to 2. In other words, the quantity of the first-type CSI processing units occupied is equal to the quantity of the CSI-RS resources, and the quantity of the second-type CSI processing units occupied is equal to 2.

For example, the purpose corresponding to the precoding matrices in the CSI reports does not include monitoring schemes for CSI calculations, and the concurrent quantity O for the CSI calculations is equal to the quantity of the CSI-RS resources.

### Example 2.11

The implementation process of S202 may include determining the quantity of the CSI-RS resources in the CSI reports and the quantity of the precoding matrices corresponding to the CSI-RS resources in the CSI reports according to the configuration information, and determining the concurrent quantity according to the comparison between the quantity of the CSI-RS resources in the CSI reports and the quantity of the precoding matrices corresponding to the CSI-RS resources in the CSI reports.

For example, the configuration information includes the quantity of the CSI-RS resources in the CSI reports and the quantity of the precoding matrices corresponding to the CSI-RS resources in the CSI reports.

For another example, the first communication node may determine the quantity of the CSI-RS resources in the CSI reports according to the information of the CSI-RS resources in the configuration information, and determine the quantity of the precoding matrices corresponding to the CSI-RS resources in the CSI reports according to the related information of the precoding matrices.

The implementation of determining the concurrent quantity according to the comparison between the quantity of the CSI-RS resources in the CSI reports and the quantity of the precoding matrices corresponding to the CSI-RS resources in the CSI reports may include determining the concurrent quantity according to a first preset rule when the quantity of the CSI-RS resources in the CSI reports is less than the quantity of the precoding matrices corresponding to the CSI-RS resources in the CSI reports, and determining the concurrent quantity according to a second preset rule when the quantity of the CSI-RS resources in the CSI reports is greater than or equal to the quantity of the precoding matrices corresponding to the CSI-RS resources in the CSI reports.

In an example, the first preset rule is determining the concurrent quantity as a difference value obtained by subtracting a fifth value from a sum of the quantity of the CSI-RS resources in the CSI-RS resource set corresponding to the CSI reports and the quantity of the precoding matrices corresponding to the CSI-RS resources in the CSI reports. The second preset rule is determining the concurrent quantity as the product of the quantity of the CSI-RS resources in the CSI-RS resource set corresponding to the CSI reports and the quantity of the precoding matrices corresponding to the CSI-RS resources in the CSI reports.

The first communication node selects CSI-RS resources from the CSI-RS resource set, reports the selected CSI-RS resources, and reports the precoding matrices corresponding to the selected CSI-RS resources. The selected CSI-RS resources herein refer to the CSI-RS resources in the CSI reports. One manner is to calculate different precoding matrices according to the selected CSI-RS resources and to report the calculated precoding matrices, that is, one selected CSI-RS resource corresponds to multiple reported precoding matrices. In other words, in the case where the quantity of the CSI-RS resources in the CSI reports is less than the quantity of the precoding matrices corresponding to the CSI-RS resources in the CSI reports, the concurrent quantity O for the CSI calculations is equal to a different value obtained by subtracting the fifth value from the sum of the quantity of the CSI-RS resources in the CSI-RS resource set and the quantity of the precoding matrices corresponding to the CSI-RS resources in the CSI reports. The fifth value may be an integer greater than 0. In an example, the fifth value may be 1. In the case where the quantity of the CSI-RS resources in the CSI reports is 1, the quantity of the precoding matrices corresponding to the CSI-RS resources in the CSI reports is 2, and the concurrent quantity O for the CSI calculations is equal to the sum of the quantity of the CSI-RS resources in the CSI-RS resource set and 1.

In another embodiment, the first communication node selects multiple different CSI-RS resources, respectively calculates different precoding matrices according to the selected different CSI-RS resources, and reports the calculated precoding matrices. In other words, in the case where the quantity of the CSI-RS resources in the CSI reports is not less than the quantity of the precoding matrices corresponding to the CSI-RS resources in the CSI reports, the concurrent quantity O for the CSI calculations is equal to the product of the quantity of the CSI-RS resources in the CSI-RS resource set and the quantity of the precoding matrices corresponding to the CSI-RS resources in the CSI reports. In the case where the quantity of the CSI-RS resources in the CSI reports is 2, the quantity of the precoding matrices corresponding to the CSI-RS resources in the CSI reports is 2, and the concurrent quantity O for the CSI calculations is equal to the product of the quantity of the CSI-RS resources in the CSI-RS resource set and 2.

The CSI-RS resources in the CSI-RS resource set are indicated by indexes of the CSI-RS resources in the CSI reports, and the precoding matrices are indicated by precoding matrix indicators in the CSI reports. Therefore, one manner includes determining the concurrent quantity O for the CSI calculations according to the quantitative comparison between the indexes of the CSI-RS resources in the CSI reports and the precoding matrix indicators corresponding to the indexes of the CSI-RS resources in the CSI reports. For example, in the case where the quantity of the indexes of the CSI-RS resources in the CSI reports is less than the quantity of the precoding matrix indicators corresponding to the indexes of the CSI-RS resources in the CSI reports, the concurrent quantity O for the CSI calculations is equal to the sum of the quantity of the indexes of the CSI-RS resources in the CSI-RS resource set and the quantity of the precoding matrix indicators corresponding to the indexes of the CSI-RS resources in the CSI reports minus 1. In the case where the quantity of the indexes of the CSI-RS resources in the CSI reports is 1, the quantity of the precoding matrix indicators corresponding to the indexes of the CSI-RS resources in the CSI reports is 2, and the concurrent quantity O for the CSI calculations is equal to the sum of the quantity of the indexes of the CSI-RS resources in the CSI-RS resource set and 1.

For another example, in the case where the quantity of the indexes of the CSI-RS resources in the CSI reports is not less than the quantity of the precoding matrix indicators corresponding to the indexes of the CSI-RS resources in the CSI reports, the concurrent quantity O for the CSI calculations is equal to the product of the quantity of the indexes of the CSI-RS resources in the CSI-RS resource set and the quantity of the precoding matrix indicators corresponding to the indexes of the CSI-RS resources in the CSI reports. In the case where the quantity of the indexes of the CSI-RS resources in the CSI reports is 2, the quantity of the precoding matrix indicators corresponding to the indexes of the CSI-RS resources in the CSI reports is 2, and the concurrent quantity O for the CSI calculations is equal to the product of the quantity of the indexes of the CSI-RS resources in the CSI-RS resource set and 2.

### Example 2.11A

The implementation process of S202 may include determining, according to the configuration information, the quantity of the CSI-RS resources in the CSI-RS resource set corresponding to the CSI reports and the quantity of the precoding matrices corresponding to the CSI-RS resources in the CSI reports, and determining the concurrent quantity according to the quantity of the CSI-RS resources in the CSI-RS resource set corresponding to the CSI reports and the quantity of the precoding matrices corresponding to the CSI-RS resources in the CSI reports.

For example, the configuration information includes the quantity of the CSI-RS resources in the CSI-RS resource set corresponding to the CSI reports and the quantity of the precoding matrices corresponding to the CSI-RS resources in the CSI reports.

For another example, the first communication node may determine the quantity of the CSI-RS resources in the CSI-RS resource set corresponding to the CSI reports according to the information of the CSI-RS resources in the configuration information, and determine the quantity of the precoding matrices corresponding to the CSI-RS resources in the CSI reports according to the related information of the precoding matrices.

For example, the concurrent quantity O for the CSI calculations is equal to the difference value obtained by subtracting the fifth value from the sum of the quantity of the CSI-RS resources in the CSI-RS resource set and the quantity of the precoding matrices corresponding to the CSI-RS resources. The fifth value may be an integer greater than 0. In an example, the fifth value may be 1. In the case where the quantity of the CSI-RS resources in the CSI reports is 1, the quantity of the precoding matrices corresponding to the CSI-RS resources in the CSI reports is 2, and the concurrent quantity O for the CSI calculations is equal to the sum of the quantity of the CSI-RS resources in the CSI-RS resource set and 1.

For another example, the concurrent quantity O for the CSI calculations is equal to the product of the quantity of the CSI-RS resources in the CSI-RS resource set and the quantity of the precoding matrices corresponding to the CSI-RS resources. In the case where the quantity of the CSI-RS resources in the CSI reports is 2, the quantity of the precoding matrices corresponding to the CSI-RS resources is 2, and the concurrent quantity O for the CSI calculations is equal to the product of the quantity of the CSI-RS resources in the CSI-RS resource set and 2.

### Example 2.12

The implementation process of S202 may include determining the quantity of the CSI-RS resources in the CSI-RS resource set corresponding to the CSI reports and the quantity of the precoding matrices in the CSI reports according to the configuration information, and determining the concurrent quantity according to the quantity of the CSI-RS resources in the CSI-RS resource set corresponding to the CSI reports and the quantity of the precoding matrices in the CSI reports.

The first communication node may determine the concurrent quantity according to the comparison between the quantity of the CSI-RS resources in the CSI-RS resource set corresponding to the CSI reports and the quantity of the precoding matrices in the CSI reports.

The first communication node may determine the quantity of the CSI-RS resources in the CSI-RS resource set corresponding to the CSI reports according to the information of the CSI-RS resources. The first communication node may determine the quantity of the precoding matrices in the CSI reports according to the related information of the precoding matrices.

The implementation of determining the concurrent quantity according to the quantity of the CSI-RS resources in the CSI-RS resource set corresponding to the CSI reports and the quantity of the precoding matrices in the CSI reports may include that the greater one of the quantity of the CSI-RS resources in the CSI-RS resource set corresponding to the CSI reports and the quantity of the precoding matrices in the CSI reports is determined as the concurrent quantity; or, the greater one of the processed quantity of the CSI-RS resources in the CSI-RS resource set corresponding to the CSI reports and the processed quantity of the precoding matrices in the CSI reports is determined as the concurrent quantity; or, a processed quantity of the CSI-RS resources in the CSI-RS resource set corresponding to the CSI reports is determined as a concurrent quantity of first-type CSI processing units, and a processed quantity of the precoding matrices in the CSI reports is determined as the concurrent quantity of the second-type CSI processing units. The processed quantity may be obtained by performing data processing on the quantity based on at least one of the four arithmetic operations with a preset value. The preset value may be an integer greater than 0.

For example, the greater one of the quantity of the CSI-RS resources in the CSI-RS resource set corresponding to the CSI reports and the quantity of the precoding matrices in the CSI reports is determined as the concurrent quantity O for CSI calculations. For another example, the greater one of the sum of the quantity of the CSI-RS resources in the CSI-RS resource set corresponding to the CSI reports and 1 and the sum of the quantity of the precoding matrices in the CSI reports and 1 is determined as the concurrent quantity O for CSI calculations. For another example, the concurrent quantity of the first-type CSI processing units for CSI calculations is equal to the quantity of the CSI-RS resources, and the concurrent quantity of the second-type CSI processing units for CSI calculations is equal to the quantity of the precoding matrices in the CSI reports. For another example, the concurrent quantity of the first-type CSI processing units for CSI calculations is equal to the quantity of the CSI-RS resources, and the concurrent quantity of the second-type CSI processing units for CSI calculations is equal to the sum of the quantity of the precoding matrices in the CSI reports and 1.

### Example 2.13

The implementation process of S202 may include determining, according to the configuration information, the quantity of the CSI-RS resources in the CSI-RS resource set corresponding to the CSI reports and the quantity of the precoding matrix indicators in the CSI reports, and determining the concurrent quantity according to the quantity of the CSI-RS resources in the CSI-RS resource set corresponding to the CSI reports and the quantity of the precoding matrix indicators in the CSI reports.

The first communication node determines the concurrent quantity according to the comparison between the quantity of the CSI-RS resources in the CSI-RS resource set corresponding to the CSI reports and the quantity of the precoding matrix indicators in the CSI reports.

The first communication node may determine the quantity of the CSI-RS resources in the CSI-RS resource set corresponding to the CSI reports according to the information of the CSI-RS resources. The first communication node may determine the quantity of the precoding matrix indicators in the CSI reports according to the related information of the precoding matrices.

The implementation of determining the concurrent quantity according to the quantity of the CSI-RS resources in the CSI-RS resource set corresponding to the CSI reports and the quantity of the precoding matrix indicators in the CSI reports may include that the greater one of the quantity of the CSI-RS resources in the CSI-RS resource set corresponding to the CSI reports and the quantity of the precoding matrix indicators in the CSI reports is determined as the concurrent quantity; alternatively, the greater one of a processed quantity of the CSI-RS resources in the CSI-RS resource set corresponding to the CSI reports and a processed quantity of the precoding matrix indicators in the CSI reports is determined as the concurrent quantity; alternatively, a processed quantity of the CSI-RS resources in the CSI-RS resource set corresponding to the CSI reports is determined as the concurrent quantity of the first-type CSI processing units, and a processed quantity of the precoding matrix indicators in the CSI reports is determined as the concurrent quantity of the second-type CSI processing units. The processed quantity here may be obtained by performing data processing on the quantity based on at least one of the four arithmetic operations with a preset value. The preset value may be an integer greater than 0.

For example, the greater one of the quantity of the CSI-RS resources in the CSI-RS resource set corresponding to the CSI reports and the quantity of the precoding matrix indicators in the CSI reports is determined as the concurrent quantity O for CSI calculations. For another example, the greater one of the sum of the quantity of the CSI-RS resources in the CSI-RS resource set corresponding to the CSI reports and 1 and the sum of the quantity of the precoding matrix indicators in the CSI reports and 1 is determined as the concurrent quantity O for CSI calculations. For another example, the concurrent quantity of the first-type CSI processing units for CSI calculations is equal to the quantity of the CSI-RS resources, and the concurrent quantity of the second-type CSI processing units for CSI calculations is equal to the quantity of the precoding matrix indicators in the CSI reports. For another example, the concurrent quantity of the first-type CSI processing units for CSI calculations is equal to the quantity of the CSI-RS resources, and the concurrent quantity of the second-type CSI processing units for CSI calculations is equal to the sum of the quantity of the precoding matrix indicators in the CSI reports and 1.

### Example 2.14

The implementation process of S202 may include determining the range of the candidate indexes of the CSI-RS resources in the CSI reports according to the configuration information, and determining the concurrent quantity according to the range of the candidate indexes of the CSI-RS resources in the CSI reports.

The first communication node may determine the range of the candidate indexes of the CSI-RS resources in the CSI reports according to the information of the CSI-RS resources.

The first communication node determines the precoding matrix acquisition scheme according to the range of the candidate indexes of the CSI-RS resources in the CSI reports, determines a quantity corresponding to the precoding matrix acquisition scheme according to a mapping relationship between scheme and quantity, and determines the quantity as the concurrent quantity.

For one CSI-RS resource, the precoding matrices may be acquired by several different calculation schemes, and different indexes corresponding to a same CSI-RS resource are used to indicate that the precoding matrices are acquired by different calculation schemes. Therefore, for CSI-RS resources in the CSI-RS resource set, different ranges of indexes of the CSI-RS resources are used to indicate different calculation schemes adopted for acquiring precoding matrices. One manner to determine the concurrent quantity O for the CSI calculations includes determining the concurrent quantity O for the CSI calculations according to the range of the candidate indexes of the CSI-RS resources in the CSI reports. For example, if the candidate indexes are in the range 1, and the precoding matrices are acquired by a first scheme, and a value mapped with the first scheme or included in the first scheme is determined as the concurrent quantity. If the candidate indexes are in the range 2, and the precoding matrices are acquired by a second scheme, and a value mapped with the second scheme or included in the second scheme is determined as the concurrent quantity. If the candidate indexes are in the range 3, the precoding matrices are acquired by a third scheme, and a value mapped with the third scheme or included in the third scheme is determined as the concurrent quantity. If the candidate indexes are in the range 4, the precoding matrices are acquired by the first scheme, and the precoding matrices are acquired by the second scheme. If the candidate indexes are in the range 5, the precoding matrices are acquired by the first scheme, the precoding matrices are acquired by the second scheme, and the precoding matrices are acquired by the first scheme and the second scheme. If the candidate indexes are in a union set of range 1 and range 2, the precoding matrices are acquired by the first scheme, and the precoding matrices are acquired by the second scheme. If the candidate indexes are in a union set of range 1, range 2 and range 3, the precoding matrices are acquired by the first scheme, the precoding matrices are acquired by the second scheme, and the precoding matrices are acquired by the first scheme and the second scheme. The precoding matrices obtained by the first scheme, the precoding matrices obtained by the second scheme and the precoding matrices obtained by the third scheme may be the same or different. The value may be included or mapped with each of the above schemes, and the value is determined as the concurrent quantity.

### Example 2.15

The implementation process of S202 may include determining a CSI report group according to the configuration information, and determining the concurrent quantity according to the CSI report group. The CSI reports in the CSI report group have a same candidate CSI-RS resource set. Alternatively, the CSI-RS resources corresponding to the CSI reports in the CSI report group are the same. Alternatively, the CSI reports in the CSI report group have the same priority.

The first communication node may determine the CSI report group according to the information of the CSI-RS resources or the information related to the precoding matrices in the configuration information. The candidate CSI-RS resource set in the present embodiment refers to the CSI-RS resource set corresponding to the CSI reports.

The implementation of determining the concurrent quantity according to the CSI report group may include pre-establishing a mapping relationship between CSI report groups and values. After the CSI report group which the CSI reports belong to is determined, a value corresponding to the CSI report group which the CSI reports belong to is determined according to the mapping relationship, and the value is determined as the concurrent quantity. The CSI report group in the present embodiment refers to a CSI report group which the CSI reports belong to.

Multiple CSI reports have some common CSI calculation parts. In an example, the common CSI calculation part is the measurement channel. In another example, the common CSI calculation part is a right eigenvector matrix of a channel coefficient matrix calculated according to a channel, and the right eigenvector matrix is an ideal precoding matrix. In another example, the common CSI calculation part is CSI-RS resources selected as CSI-RS resources to be reported. The common calculation parts of different CSI reports do not need to be calculated repeatedly to save calculation power or calculation units. Therefore, multiple CSI reports are grouped into one group and the concurrent quantity O for the CSI calculations is determined according to the CSI report group, so that the calculation amount is saved and the calculation efficiency is improved. One manner to determine the concurrent quantity O for the CSI calculations includes determining the concurrent quantity O for the CSI calculations according to the CSI report group. For example, Y CSI reports that measure the same candidate CSI-RS resource set are grouped into a same CSI report group, and the concurrent quantity for CSI calculations is determined according to the CSI report group. For another example, Y CSI reports that select the same CSI-RS resources as the report resource are grouped into a same CSI report group, and the concurrent quantity for CSI calculations is determined according to the CSI report group. For another example, Y reports that have the same priority are grouped into a same CSI report group, and the concurrent quantity for CSI calculations is determined according to the CSI report group.

### Example 2.16

The implementation process of S202 may include determining the required processing time duration of the CSI reports according to the configuration information, and determining the concurrent quantity according to the required processing time duration of the CSI reports.

The first communication node may determine the required processing time duration of the CSI reports according to the information of the CSI-RS resources or the information related to the precoding matrices in the configuration information.

The implementation of determining the concurrent quantity according to the required processing time duration of the CSI reports may include determining the concurrent quantity according to the required processing time duration of the CSI reports and the preset rules. The required processing time duration of the CSI reports may be referred to as a processing time duration of the CSI reports, a CSI report processing time duration, or a time duration for processing the CSI reports.

The preset rules here may be as follows: when the required processing time duration of the CSI reports is greater than or equal to a preset time threshold, the concurrent quantity is equal to a first quantity; when the required processing time duration of the CSI reports is less than the preset time threshold, the concurrent quantity is equal to a second quantity. The second quantity is greater than the first quantity. The first quantity and the second quantity are integers greater than 0.

When the processing time duration of the CSI reports is long, the concurrent quantity for CSI calculations required is small, however in this case, if the concurrent quantity actually used for CSI calculations is large, the CSI processing units are wasted. When the processing time duration of the CSI reports is short, and the CSI calculations are required to be accelerated, a greater concurrent quantity for CSI calculations is required, however in this case, if the concurrent quantity actually used for CSI calculations is less, the CSI calculations task cannot be completed within the specified time. One possible manner to determine the concurrent quantity for CSI calculations includes determining the concurrent quantity O for the CSI calculations according to the processing time duration for processing the CSI reports. According to the time duration for processing the CSI reports, the concurrent quantity O for the CSI calculations is determined, and the concurrent quantity for CSI calculations matching the time duration for processing the CSI reports is acquired, so that the CSI calculations task can be completed within a specified time duration and the CSI processing units can be saved. For example, in the case where the time duration for processing CSI reports is T, the concurrent quantity O for the CSI calculations is 1. In the case where the time duration for processing CSI reports is T/2, the concurrent quantity for CSI calculations is 2. For another example, in the case where the time duration for processing CSI reports is 5 slots, the concurrent quantity O for the CSI calculations is 2. In the case where the time duration for processing the CSI reports is 3 slots, the concurrent quantity O for the CSI calculations is 4. T is a number greater than 0.

### Example 2.17

The implementation process of S202 may include determining the subcarrier spacing according to the configuration information, and determining the concurrent quantity according to the subcarrier spacing.

The first communication node may determine the subcarrier spacing according to the information of the CSI-RS resources or the information related to the precoding matrices in the configuration information, or determine the subcarrier spacing according to other information in the configuration information.

The implementation of determining the concurrent quantity according to the subcarrier spacing may include pre-establishing a mapping relationship between the subcarrier spacings and the values. After the subcarrier spacing is determined, a value corresponding to the subcarrier spacing is determined according to the mapping relationship and determined as the concurrent quantity.

The time duration of the slot in an orthogonal frequency division multiplexing (OFDM) system is determined by the subcarrier spacing. The actual CSI report processing time duration with a fixed quantity of slots is determined by the subcarrier spacing. One manner includes determining the concurrent quantity O for the CSI calculations according to the subcarrier spacing. For example, in the case where the subcarrier spacing is 15 kHz and the CSI report processing time duration is 4 slots, the concurrent quantity O for the CSI calculations is 2. In the case where the subcarrier spacing is 30 kHz and the CSI report processing time duration is 4 slots, the concurrent quantity O for the CSI calculations is 4. For example, in the case where the subcarrier spacing is 15 kHz and the CSI report processing time is 6 slots, the concurrent quantity for CSI calculations O is 1. In the case where the subcarrier spacing is 30 kHz and the CSI report processing time is 6 slots, the concurrent quantity O for the CSI calculations is 3.

The above shows various implementations of determining, according to the configuration information, the concurrent quantity according to the present embodiment.

The concurrent quantity determined in the present embodiment includes the concurrent quantity of at least two types of the CSI processing units. In other words, the types of the CSI processing units and the concurrent quantity corresponding to each type of the CSI processing units are determined.

The concurrent quantity determined in the present embodiment may also include the concurrent quantity of only one type of the CSI processing units.

In the present embodiment, after the CSI reports are processed by the first communication node, the CSI reports are sent to the second communication node by the first communication node so that the second communication node determines the channel state information according to the CSI reports, and then determines a strategy for data transmission.

The following describes the relevant contents of the CSI reports obtained after executing S203 in the present embodiment.

Wireless communication evolves to the 5th generation communication technology. LTE technology in the 4th generation wireless communication technology and NR technology in the 5th generation wireless communication technology are based on OFDM technology. In OFDM technology, the smallest frequency domain unit is a subcarrier, and the smallest time domain unit is an OFDM symbol. A resource block is defined to facilitate the use of the frequency domain resources, and one resource block is defined as a specific quantity of consecutive subcarriers. A bandwidth part (BWP) is defined, and one bandwidth part is defined as another specific quantity of consecutive resource blocks on a carrier. A slot is defined to facilitate the use of the time domain resources, and one slot is defined as another specific quantity of consecutive OFDM symbols.

The second communication node sends a reference signal. The first communication node measures the reference signal, determines the channel state information from the second communication node to the first communication node, and reports the CSI reports to the second communication node. The second communication node receives the CSI reports reported by the first communication node. The second communication node determines the strategy for data transmission according to the channel state represented by the received CSI reports, and transmits data, thereby improving the efficiency of data transmission. The transmission strategy of the second communication node is affected by the accuracy of the channel state represented by the channel state information, resulting in the efficiency of data transmission being affected. When the channel state information received by the second communication node is more comprehensive, it is more beneficial to formulate an appropriate strategy for data transmission, thus improving the system performance. Therefore, the second communication node wants the first communication node to report multiple channel state information reports in a short time, for example, reports corresponding to transmit beams from different antennas of the second communication node; for another example, reports corresponding to different quantities of antenna ports; for another example, reports corresponding to different precoding codebooks; for another example, reports corresponding to different precoding acquisition schemes; for another example, the report corresponding to different information of monitoring precoding acquisition schemes; for another example, reports corresponding to different report content combinations. The CSI report processing method according to the present embodiment can improve the processing efficiency of CSI reports and the efficiency of the first communication node in reporting the CSI reports, so that the channel state information received by the second communication node becomes more comprehensive, and it is beneficial for the second communication node to formulate an appropriate data transmission strategy, thereby improving the system performance.

The reference signal sent by the second communication node to the first communication node is a downlink reference signal. In LTE system, the downlink reference signal used for reporting channel state information includes cell-specific reference signal (CRS) and channel-state information reference signal (CSI-RS). In NR system, the downlink reference signal used for reporting channel state information includes CSI-RS. CSI-RS is carried by a channel state information reference signal resource (CSI-RS Resource), and the CSI-RS resource is composed of a code division multiplexing group (CDM group). The CDM group is composed of radio resource elements. A multiplexing manner of CSI-RSs of a group of CSI-RS ports on one CDM group is code division multiplexing.

A content of the channel state information transmitted between the second communication node and the first communication node includes a channel quality indicator (CQI) used to indicate the quality of the channel, alternatively, includes a precoding matrix indicator (PMI) used to indicate the precoding matrices applied to the base station antenna. A reporting format of one type of CQI is wideband CQI reporting, that is, one channel quality is reported for the channel state information reporting band (CSI reporting band), and the channel quality corresponds to the entire channel state information reporting band; a reporting format of another type of CQI is subband CQI reporting, that is, channel quality is given for each subband of the CSI reporting band, where one channel quality corresponds to one subband, that is, one channel quality is reported for each subband of CSI reporting band. The subband is the frequency domain units and is defined as N consecutive RB, where N is a positive integer. For ease of description, in the present disclosure, the subband is referred to as channel quality indicator subband, or CQI subband, or subband; where N is referred to as the size of the CQI subband, or the CQI subband size, or the subband size. The bandwidth part is divided into subbands, and the CSI reporting band is defined by a subset of the subbands of BWP. CSI reporting band is a band of which the channel state information needs to be reported.

In an embodiment, the channel quality is determined according to the strength of the reference signal received by the first communication node. In another embodiment, the channel quality is determined according to the signal-to-noise ratio of the received reference signal. In the channel state information reporting band, if the channel quality varies little, CQI is reported by wideband CQI reporting so that the resource overheads for CQI reporting are reduced; if the channel quality varies greatly in the frequency domain, CQI is reported by subband CQI reporting so that the accuracy of CQI reporting is increased.

A reporting format of one type of PMI is wideband PMI reporting, that is, one PMI is reported for the CSI reporting band, and the PMI corresponds to the entire CSI reporting band. A reporting format of another type of PMI is subband PMI reporting, that is, PMI is reported for each subband of the channel state information reporting band, alternatively, a component of PMI is reported for each subband of the channel state information reporting band. For example, PMI is composed of X1 and X2, and one manner to report a component of PMI for each subband of the channel state information reporting band is to report an X1 for the entire band and report an X2 for each subband. Another manner to report a component of PMI for each subband of the channel state information reporting band is to report an X1 and an X2 for each subband.

A reporting format of another type of PMI includes that the reported PMI indicates R precoding matrices for each subband, where R is a positive integer. In the sense of the frequency domain granularity for feeding back the precoding matrices, R in turn denotes a quantity of precoding matrix subbands included in each subband, or a quantity of precoding matrix subbands included in each CQI subband.

In the embodiments of the present disclosure, the configuration information sent by the second communication node is received, the concurrent quantity of CSI processing units is determined according to the configuration information, and CSI reports are processed using at least one CSI processing unit, where the number of the at least one CSI processing unit is equal to the concurrent quantity, thereby improving the processing efficiency of CSI reports and further improving the efficiency of data transmission.

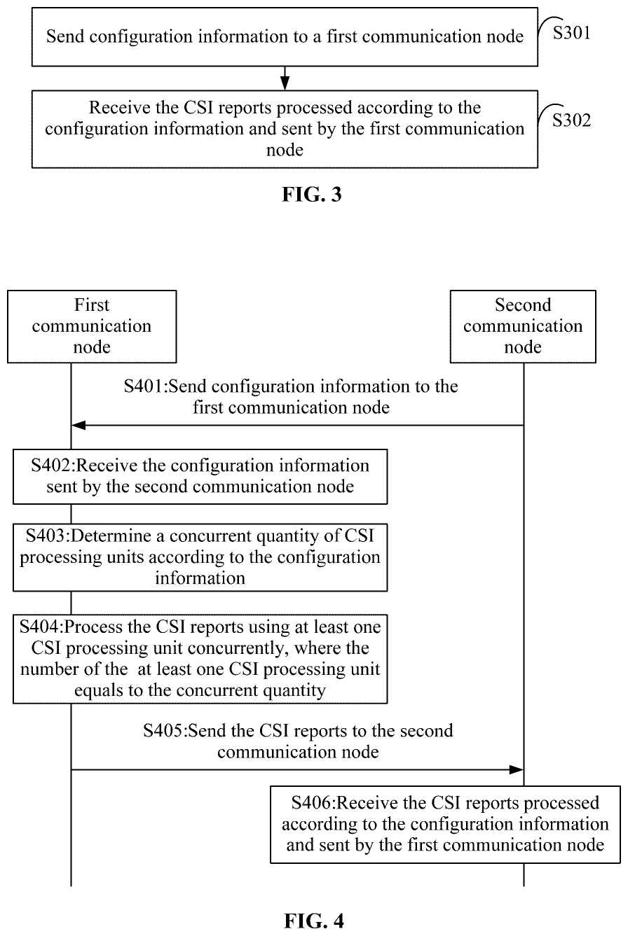

FIG. 3 is another flowchart of a method for processing CSI reports according to an embodiment of the present disclosure. As shown in FIG. 3, the method for processing CSI reports according to the present embodiment is applicable to a second communication node. In the present embodiment, the second communication node (also referred to as the second communication node equipment) may be an access network equipment, such as a base station. The method for processing CSI reports includes S301-S302.

S301: configuration information is sent to a first communication node.

S302: CSI reports processed according to the configuration information and sent by the first communication node are received.

The CSI reports are processed by the first communication node using at least one CSI processing unit concurrently, the number of the at least one CSI processing unit is equal to a concurrent quantity of CSI processing units, and the concurrent quantity is determined by the first communication node according to the configuration information.

After the CSI reports sent by the first communication node are received, the second communication node determines the data transmission strategy according to the CSI reports, and data transmission between the first communication node and the second communication node is performed according to the data transmission strategy.

Before S301, the second communication node receives the capability information sent by the first communication node. The second communication node determines the configuration information according to the capability information sent by the first communication node, and sends the configuration information to the first communication node. The capability information in the present embodiment refers to the information of the capabilities supported by the first communication node.

In an example, the capability information in the present embodiment may include at least one of the following: the quantity of the CSI processing units, the CSI processing unit, and the quantity of the CSI processing units corresponding to the CSI processing unit.

In an embodiment, the configuration information may include at least one of the following: information of the CSI-RS resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition schemes, groups of precoding matrix acquisition schemes, or information for monitoring precoding matrix acquisition schemes.

In an embodiment, when the configuration information includes information of the CSI-RS resources or groups of CSI-RS resources, the first communication node determines the concurrent quantity according to the quantity of the CSI-RS resources or the quantity of the groups of the CSI-RS resources.

In an example, the first communication node determines the concurrent quantity in the following manners: the quantity of the CSI-RS resources is determined as the concurrent quantity; alternatively, a sum of the quantity of the CSI-RS resources and a preset first value is determined as the concurrent quantity; alternatively, the greater one of the quantity of the CSI-RS resources and a preset second value is determined as the concurrent quantity; alternatively, the quantity of the groups of the CSI-RS resources is determined as the concurrent quantity. The groups of the CSI-RS resources include groups of CSI-RS resources generated by grouping in a manner of quantity-based even partitioning, or each group of CSI-RS resources generated by grouping in a manner of computing-power-requirement-based even partitioning, or each group of CSI-RS resources generated by grouping in a manner of CSI-processing-unit-computing-power-based matching partitioning.

In an embodiment, the first communication node determines the quantity of the precoding matrices or the quantity of the groups of the precoding matrices according to the configuration information, and determines the concurrent quantity according to the quantity of the precoding matrices or the quantity of the groups of the precoding matrices.

In an example, the first communication node determines the concurrent quantity in the following manners: the quantity of the precoding matrices is determined as the concurrent quantity; alternatively, a sum of the quantity of the precoding matrices and a preset third value is determined as the concurrent quantity; alternatively, the greater one of greater one of the quantity of the precoding matrices and a preset fourth value is determined as the concurrent quantity; alternatively, the quantity of the groups of the precoding matrices is determined as the concurrent quantity. The groups of the precoding matrices include groups of the precoding matrices generated by grouping in a manner of quantity-based even partitioning, or by grouping in a manner of computing-power-requirement-based even partitioning, or by grouping in a manner of CSI-processing-unit-computing-power-based matching partitioning.

In an embodiment, when the configuration information is the target data, the first communication node determines the quantity of pieces of the target data as the concurrent quantity. The pieces of target data include one of the codebooks of the precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition scheme or groups of precoding matrix acquisition scheme. The groups of the codebooks of the precoding matrices, the groups of ranks of precoding matrices, the groups of layers of precoding matrices, the groups of overheads of precoding matrices, the groups of machine learning models, the groups of frequency domain units and the the groups of precoding matrix acquisition scheme each include: a group generated by grouping in a manner of quantity-based even partitioning, or by grouping in a manner of computing-power-requirement-based even partitioning, or by grouping in a manner of CSI-processing-unit-computing-power-based matching partitioning.

In an embodiment, the first communication node determines the quantity of the CSI-RS resources in the CSI-RS resource set corresponding to the CSI reports and the purpose of the precoding matrices in the CSI reports according to the configuration information, and determines the concurrent quantity according to the quantity of the CSI-RS resources in the CSI-RS resource set corresponding to the CSI reports and the purpose of the precoding matrices in the CSI reports.

In an example, when the concurrent quantity is determined according to the quantity of the CSI-RS resources in the CSI-RS resource set corresponding to the CSI reports and the purpose of the precoding matrices in the CSI reports, the first communication node determines the concurrent quantity in the following manners: a rule corresponding to the purpose of the precoding matrices in the CSI reports is determined according to the purpose of the precoding matrices in the CSI reports; the concurrent quantity is determined according to the rule corresponding to the purpose of the precoding matrices in the CSI reports and the quantity of the CSI-RS resources in the CSI-RS resource set corresponding to the CSI reports.

In an embodiment, the first communication node determines the quantity of the CSI-RS resources in the CSI reports and the quantity of the precoding matrices corresponding to the CSI-RS resources in the CSI reports according to the configuration information, and determines the concurrent quantity according to the comparison between the quantity of the CSI-RS resources in the CSI reports and the quantity of the precoding matrices corresponding to the CSI-RS resources in the CSI reports.

In an example, when the concurrent quantity is determined according to the comparison between the quantity of the CSI-RS resources in the CSI reports and the quantity of the precoding matrices corresponding to the CSI-RS resources, the first communication node determines the concurrent quantity in the following manners: the concurrent quantity is determined according to a first preset rule when the quantity of the CSI-RS resources in the CSI reports is less than the quantity of the precoding matrices corresponding to the CSI-RS resources in the CSI reports; the concurrent quantity is determined according to a second preset rule when the quantity of the CSI-RS resources in the CSI reports is greater than or equal to the quantity of the precoding matrices corresponding to the CSI-RS resources in the CSI reports.

The first preset rule is determining the concurrent quantity as a difference value obtained by subtracting a fifth value from a sum of the quantity of the CSI-RS resources in the CSI-RS resource set corresponding to the CSI reports and the quantity of the precoding matrices corresponding to the CSI-RS resources in the CSI reports. The second preset rule is determining the concurrent quantity as a product of the quantity of the CSI-RS resources in the CSI-RS resource set corresponding to the CSI reports and the quantity of the precoding matrices corresponding to the CSI-RS resources in the CSI reports.

In an embodiment, the first communication node determines the quantity of the CSI-RS resources in the CSI-RS resource set corresponding to the CSI reports and the quantity of the precoding matrices in the CSI reports according to the configuration information, and determines the concurrent quantity according to the quantity of the CSI-RS resources in the CSI-RS resource set corresponding to the CSI reports and the quantity of the precoding matrices in the CSI reports.

In an example, when the concurrent quantity is determined according to the quantity of the CSI-RS resources in the CSI-RS resource set corresponding to the CSI reports and the quantity of the precoding matrices in the CSI reports, the first communication node determines the concurrent quantity in the following manners: the greater one of the quantity of the CSI-RS resources in the CSI-RS resource set corresponding to the CSI reports and the quantity of the precoding matrices in the CSI reports is determined as the concurrent quantity; alternatively, the greater one of the processed quantity of the CSI-RS resources in the CSI-RS resource set corresponding to the CSI reports and the processed quantity of the precoding matrices in the CSI reports is determined as the concurrent quantity; alternatively, the processed quantity of the CSI-RS resources in the CSI-RS resource set corresponding to the CSI reports is determined as the concurrent quantity of the first-type CSI processing units, and the processed quantity of the precoding matrices in the CSI reports is determined as the concurrent quantity of the second-type CSI processing units.

In an embodiment, the first communication node determines the quantity of the CSI-RS resources in the CSI-RS resource set corresponding to the CSI reports and the quantity of the precoding matrix indicators in the CSI reports according to the configuration information, and determines the concurrent quantity according to the quantity of the CSI-RS resources in the CSI-RS resource set corresponding to the CSI reports and the quantity of the precoding matrix indicators in the CSI reports.

In an embodiment, the first communication node determines a range of the candidate indexes of the CSI-RS resources in the CSI reports according to configuration information, and determines the concurrent quantity according to the range of the candidate indexes of the CSI-RS resources in the CSI reports.

In an embodiment, the first communication node determines a CSI report group according to configuration information, and determines the concurrent quantity according to the CSI report group. The CSI reports in the CSI report group have a same candidate CSI-RS resource set. Alternatively, the CSI-RS resources corresponding to the CSI reports in the CSI report group are the same. Alternatively, the CSI reports in the CSI report group have a same priority.

In an embodiment, the first communication node determines the required processing time duration of the CSI reports according to the configuration information, and determines the concurrent quantity according to the required processing time duration of the CSI reports.

In an embodiment, the first communication node determines the subcarrier spacing according to the configuration information, and determines the concurrent quantity according to the subcarrier spacing.

In an embodiment, the concurrent quantity includes the concurrent quantity of at least two types of the CSI processing units.

In the method for processing CSI reports according to the present embodiment, the configuration information is sent to the first communication node, and the CSI reports processed according to the configuration information and sent by the first communication node are received. The CSI reports are processed by the first communication node using at least one CSI processing unit concurrently, the number of the at least one CSI processing unit is equal to a concurrent quantity of CSI processing units, and the concurrent quantity is determined by the first communication node according to the configuration information. In this manner, it is implemented that the first communication node determines the concurrent quantity according to the configuration information, and uses the CSI processing units corresponding to the concurrent quantity to process the CSI reports in a concurrent manner, and the second communication node receives the CSI reports. Since the processing efficiency of the CSI reports is improved, the channel state information received by the second communication node becomes more comprehensive, and it is beneficial for the second communication node to formulate an appropriate data transmission strategy, thereby improving the system performance.

FIG. 4 is yet another interactive schematic diagram of a method for processing CSI reports according to an embodiment of the present disclosure. The present embodiment describes the CSI report processing method according to the present embodiment from the perspective of interaction between a first communication node and a second communication node. As shown in FIG. 4, the CSI report processing method according to the present embodiment includes S401-S406.

S401: configuration information is sent to the first communication node.

S402: the configuration information sent by the second communication node is received.

S403: a concurrent quantity of the CSI processing units is determined according to the configuration information.

S404: CSI reports are processed using at least one CSI processing unit concurrently, where the number of the at least one CSI processing unit is equal to the concurrent quantity.

S405: the CSI reports are sent to the second communication node.

S406: the CSI reports processed according to the configuration information and sent by the first communication node are received.

The implementation of the configuration information in the present embodiment, the implementation of determining, according to the configuration information, the concurrent quantity, and the implementation of using CSI processing units corresponding to the concurrent quantity to process CSI reports each has a same technical principle and implementation process as the embodiments and various implementations shown in FIGS. 2 and 3, and each has a same technical effect. Details are not described herein again.

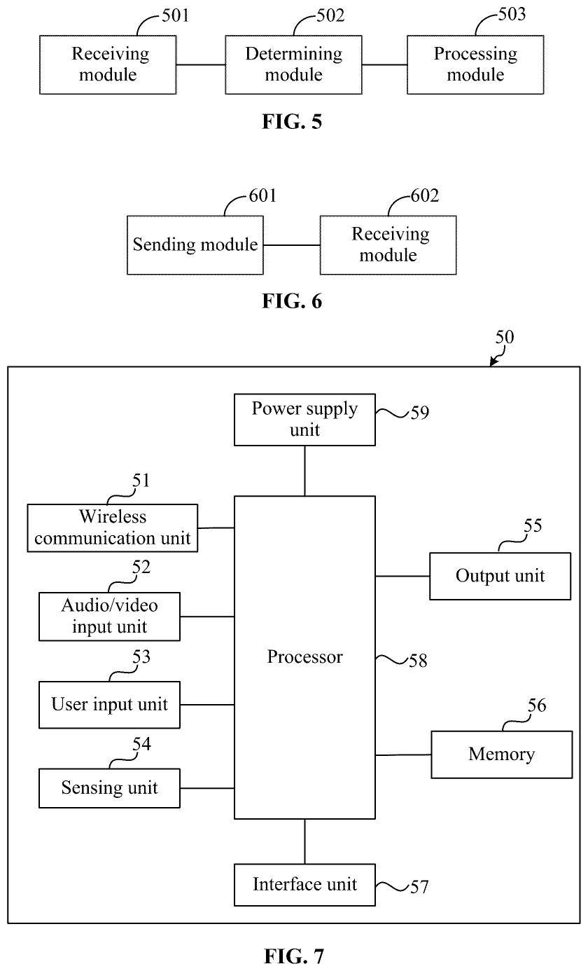

FIG. 5 is a schematic structural diagram of an apparatus for processing CSI reports according to an embodiment of the present disclosure. The apparatus for processing CSI reports may be configured in a first communication node. As shown in FIG. 5, the apparatus for processing CSI reports according to the present embodiment includes the following modules.

A receiving module 501 is configured to receive configuration information sent by a second communication node.

The determining module 502 is configured to determine a concurrent quantity of CSI processing units according to the configuration information.

The processing module 503 is configured to use at least one CSI processing unit to process the CSI reports concurrently, where the number of the at least one CSI processing unit is equal to the concurrent quantity.

In an embodiment, the configuration information may include at least one of the following: information of the CSI-RS resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition schemes, groups of precoding matrix acquisition schemes, or information for monitoring precoding matrix acquisition schemes.

The information of the CSI-RS resources is used to indicate at least one of the following: the CSI-RS resources in a CSI-RS resource set corresponding to the CSI reports, the quantity of the CSI-RS resources in a CSI-RS resource set corresponding to the CSI reports, the quantity of the CSI-RS resources in the CSI reports, or a range of the candidate indexes of the CSI-RS resources in the CSI reports. The difference between the CSI-RS resources in the CSI-RS resource set corresponding to the CSI reports and the CSI-RS resources in the CSI reports is that the CSI-RS resources in the CSI-RS resource set corresponding to the CSI reports refer to candidate CSI-RS resources corresponding to the CSI reports, while the CSI-RS resources in the CSI reports refer to selected CSI-RS resources in the CSI reports. The CSI-RS resources in the CSI reports are a subset of the CSI-RS resources in the CSI-RS resource set corresponding to the CSI reports.

The overheads of the precoding matrices refer to the resources required after the precoding matrices are compressed. In an example, the overheads of the precoding matrices may refer to the quantity of bits required after the precoding matrices are compressed.

The machine learning models are used to output the precoding matrices. The machine learning models in the present embodiment may be models trained by various machine learning methods. For example, the machine learning models may be an artificial intelligence model, such as a neural network and a convolutional neural network.

The frequency domain units in the present embodiment may be a frequency domain unit defined according to requirement. For example, the frequency domain units in the present embodiment may be an RB, or a subband.

The information for monitoring precoding matrix acquisition schemes includes at least one of the following: whether to monitor and report the precoding matrix acquisition schemes, the content monitored and reported, the format of the monitoring and reporting, etc.

In an embodiment, when the configuration information includes information of the CSI-RS resources or groups of CSI-RS resources, the determining module 502 is configured to determine the concurrent quantity according to the quantity of the CSI-RS resources or the quantity of the groups of the CSI-RS resources.

In an example, the determining module 502 is configured to determine the concurrent quantity in the following manners: the quantity of the CSI-RS resources is determined as the concurrent quantity; alternatively, a sum of the quantity of the CSI-RS resources and a preset first value is determined as the concurrent quantity; alternatively, the greater one of the quantity of the CSI-RS resources and a preset second value is determined as the concurrent quantity; alternatively, the quantity of the groups of the CSI-RS resources is determined as the concurrent quantity. The groups of the CSI-RS resources include groups of CSI-RS resources generated by grouping in a manner of quantity-based even partitioning, or by grouping in a manner of computing-power-requirement-based even partitioning, or by grouping in a manner of CSI-processing-unit-computing-power-based matching partitioning.

In an embodiment, the determining module 502 is configured to determine the quantity of the precoding matrices or the quantity of the groups of the precoding matrices according to the configuration information, and determine the concurrent quantity according to the quantity of the precoding matrices or the quantity of the groups of the precoding matrices.

In an example, the determining module 502 is configured to determine the concurrent quantity in the following manners: the quantity of the precoding matrices is determined as the concurrent quantity; alternatively, a sum of the quantity of the precoding matrices and a preset third value is determined as the concurrent quantity; alternatively, the greater one of the quantity of the precoding matrices and a preset fourth value is determined as the concurrent quantity; alternatively, the quantity of the groups of the precoding matrices is determined as the concurrent quantity. The groups of the precoding matrices include groups of the precoding matrices generated by grouping in a manner of quantity-based even partitioning, or by grouping in a manner of computing-power-requirement-based even partitioning, or by grouping in a manner of CSI-processing-unit-computing-power-based matching partitioning.

In an embodiment, when the configuration information is target data, the determining module 502 is configured to determine the quantity of pieces of the target data as the concurrent quantity. The pieces of the target data include any one of the codebooks of the precoding matrices, groups of codebooks of precoding matrices, ranks of precoding matrices, groups of ranks of precoding matrices, layers of precoding matrices, groups of layers of precoding matrices grouping, overheads of precoding matrices, groups of overheads of precoding matrices, machine learning models, groups of machine learning models, frequency domain units, groups of frequency domain units, precoding matrix acquisition scheme or groups of precoding matrix acquisition scheme. The groups of the codebooks of the precoding matrices, the groups of ranks of precoding matrices, the groups of layers of precoding matrices, the groups of overheads of precoding matrices, the groups of machine learning models, the groups of the frequency domain units and the groups of precoding matrix acquisition scheme each include: corresponding groups generated by grouping in a manner of quantity-based even partitioning, or each group generated by grouping in a manner of computing-power-requirement-based even partitioning, or each group generated by grouping in a manner of CSI-processing-unit-computing-power-based matching partitioning.

In an embodiment, the determining module 502 is configured to determine the quantity of the CSI-RS resources in the CSI-RS resource set corresponding to the CSI reports and the purpose of the precoding matrices in the CSI reports according to the configuration information, and determine the concurrent quantity according to the quantity of the CSI-RS resources in the CSI-RS resource set corresponding to the CSI reports and the purpose of the precoding matrices in the CSI reports.

In an example, when the concurrent quantity is determined according to the quantity of the CSI-RS resources in the CSI-RS resource set corresponding to the CSI reports and the purpose of the precoding matrices in the CSI reports, the determining module 502 is configured to determine the concurrent quantity in following manners: a rule corresponding to the purpose of the precoding matrices is determined according to the purpose of the precoding matrices in the CSI reports; the concurrent quantity is determined according to the rule corresponding to the purpose of the precoding matrices in the CSI reports and the quantity of the CSI-RS resources in the CSI-RS resource set corresponding to the CSI reports.

In an embodiment, the determining module 502 is configured to determine the quantity of the CSI-RS resources in the CSI reports and the quantity of the precoding matrices corresponding to the CSI-RS resources in the CSI reports according to the configuration information, and determine the concurrent quantity according to the comparison between the quantity of the CSI-RS resources in the CSI reports and the quantity of the precoding matrices corresponding to the CSI-RS resources in the CSI reports.

In an example, when the concurrent quantity is determined according to the comparison between the quantity of the CSI-RS resources in the CSI reports and the quantity of the precoding matrices corresponding to CSI-RS resources in the CSI reports, the determining module 502 is configured to determine the concurrent quantity in the following manners: if the quantity of the CSI-RS resources in the CSI reports is less than the quantity of the precoding matrices corresponding to the CSI-RS resources in the CSI reports, the concurrent quantity is determined according to a first preset rule; if the quantity of the CSI-RS resources in the CSI reports is greater than or equal to the quantity of the precoding matrices corresponding to the CSI-RS resources in the CSI reports, the concurrent quantity is determined according to a second preset rule.

The first preset rule is determining the concurrent quantity as a difference value obtained by subtracting a fifth value from a sum of the quantity of the CSI-RS resources in the CSI-RS resource set corresponding to the CSI reports and the quantity of the precoding matrices corresponding to the CSI-RS resources in the CSI reports. The second preset rule is determining the concurrent quantity as the product of the quantity of the CSI-RS resources in the CSI-RS resource set corresponding to the CSI reports and the quantity of the precoding matrices corresponding to the CSI-RS resources in the CSI reports.

In an embodiment, the determining module 502 is configured to determine the quantity of the CSI-RS resources in the CSI-RS resource set corresponding to the CSI reports and the quantity of the precoding matrices in the CSI reports according to the configuration information, and determine the concurrent quantity according to the quantity of the CSI-RS resources in the CSI-RS resource set corresponding to the CSI reports and the quantity of the precoding matrices in the CSI reports.

In an example, when the concurrent quantity is determined according to the quantity of the CSI-RS resources in the CSI-RS resource set corresponding to the CSI reports and the quantity of the precoding matrices in the CSI reports, the determining module 502 is configured to determine the concurrent quantity in the following manners: the greater one of the quantity of the CSI-RS resources in the CSI-RS resource set corresponding to the CSI reports and the quantity of the precoding matrices in the CSI reports is determined as the concurrent quantity; alternatively, the greater one of the processed quantity of the CSI-RS resources in the CSI-RS resource set corresponding to the CSI reports and the processed quantity of the precoding matrices in the CSI reports is determined as the concurrent quantity; alternatively, the processed quantity of the CSI-RS resources in the CSI-RS resource set corresponding to the CSI reports is determined as the concurrent quantity of the first-type CSI processing units, and the processed quantity of the precoding matrices in the CSI reports is determined as the concurrent quantity of the second-type CSI processing units, where the processed quantity is obtained by performing data processing on the quantity.

In an embodiment, the determining module 502 is configured to determine the quantity of the CSI-RS resources in the CSI-RS resource set corresponding to the CSI reports and the quantity of the precoding matrix indicators in the CSI reports according to the configuration information, and determine the concurrent quantity according to the quantity of the CSI-RS resources in the CSI-RS resource set corresponding to the CSI reports and the quantity of the precoding matrix indicators in the CSI reports.

In an embodiment, the determining module 502 is configured to determine a range of the candidate indexes of the CSI-RS resources in the CSI reports according to the configuration information, and determine the concurrent quantity according to the range of the candidate indexes of the CSI-RS resources in the CSI reports.

In an embodiment, the determining module 502 is configured to determine the CSI report group according to the configuration information, and determine the concurrent quantity according to the CSI report group. The CSI reports in the CSI report group have a same candidate CSI-RS resource set, or the CSI-RS resources corresponding to the CSI reports in the CSI report group are the same, or the CSI reports in the CSI report group have the same priority.

In an embodiment, the determining module 502 is configured to determine the required processing time duration of the CSI reports according to the configuration information, and determine the concurrent quantity according to the required processing time duration of the CSI reports.

In an embodiment, the determining module 502 is configured to determine the subcarrier spacing according to the configuration information, and determine the concurrent quantity according to the subcarrier spacing.

In an embodiment, the concurrent quantity includes the concurrent quantity of at least two types of the CSI processing units.

The apparatus for processing CSI reports according to the present embodiment aims to implement the CSI report processing method in the above embodiments, and the apparatus for processing CSI reports according to the present embodiment has a same implementation principle and technical effect as the above embodiments. Details are not described herein again.

FIG. 6 is another schematic structural diagram of an apparatus for processing CSI reports according to an embodiment of the present disclosure. The apparatus for processing channel state information report may be configured in a second communication node. As shown in FIG. 6, the apparatus for processing CSI reports according to the present embodiment includes the following modules.

A sending module 601 is configured to send configuration information to a first communication node.

A receiving module 602 is configured to receive channel state information (CSI) reports processed according to the configuration information and sent by the first communication node.

The CSI reports are processed by the first communication node using at least one CSI processing unit concurrently, the number of the at least one CSI processing unit is equal to a concurrent quantity of CSI processing units, and the concurrent quantity is determined by the first communication node according to the configuration information.

In an embodiment, the configuration information includes at least one of the following: information of CSI-reference signal (RS) resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition scheme, groups of precoding matrix acquisition schemes or information for monitoring precoding matrix acquisition schemes.

The apparatus for processing CSI reports according to the present embodiment aims to implement the CSI report processing method in the above embodiments, and the apparatus for processing CSI reports according to the present embodiment has a same implementation principle and technical effect as the above embodiments. Details are not described herein again.

The embodiments of the present disclosure further provide a communication node including a processor. The processor is used for implementing the method provided by any embodiment of the present disclosure when executing a computer program. The communication node may be a first communication node or a second communication node. The first communication node includes a processor for implementing the method for processing CSI reports provided by any embodiment of the present disclosure when executing a computer program. The second communication node includes a processor for implementing the method for processing CSI reports provided by any embodiment of the present disclosure when executing a computer program. In an example, the first communication node may be a terminal equipment provided by any embodiment of the present disclosure, such as a UE. The second communication node may be an access network equipment provided by any embodiment of the present disclosure, such as a base station, and it is not limited by the present disclosure.

In an example, the following embodiments respectively provide a structural schematic diagram of the communication node being a terminal and a structural schematic diagram of the communication node being a base station.

FIG. 7 is a schematic structural diagram of a terminal according to an embodiment of the present disclosure. The terminal may be implemented in various forms. The terminal in the present disclosure may include, but is not limited to a mobile terminal equipment such as a mobile phone, a smart phone, a notebook computer, a digital broadcast receiver, a personal digital assistant (PDA), a portable device, PAD), a portable media player (PMP), a navigation device, a vehicle-mounted terminal equipment, a vehicle-mounted display terminal, and a vehicle-mounted electronic rearview mirror. The terminal may include, but is not limited to a fixed terminal equipment such as a digital television (TV) and a desktop computer.

As shown in FIG. 7, the terminal 50 may include a wireless communication unit 51, an audio/video (A/V) input unit 52, a user input unit 53, a sensing unit 54, an output unit 55, a memory 56, an interface unit 57, a processor 58, a power supply unit 59, etc. FIG. 7 illustrates a terminal including various components, but not all illustrated components are required to be implemented. Alternatively, the terminal 50 may be implemented with more or fewer components.

In the present embodiment, the wireless communication unit 51 allows radio communication between the terminal 50 and a base station or a network. The A/V input unit 52 is configured to receive audio or video signals. The user input unit 53 may generate key input data according to commands input by the user to control various operations of the terminal 50. The sensing unit 54 detects the current state of the terminal 50, the position of the terminal 50, the presence or absence of a user's touch input to the terminal 50, the orientation of the terminal 50, the acceleration or deceleration movement and direction of the terminal 50, and the like, and generates a command or signal for controlling the operation of the terminal 50. The interface unit 57 serves as an interface through which at least one external equipment can connect with the terminal 50. The output unit 55 is configured to provide an output visual, audio and/or tactile signals. The memory 56 may store software programs for processing and control operations performed by the processor 58, etc., or may temporarily store data that has been or is to be output. The memory 56 may include storage medium of at least one type. Moreover, the terminal 50 may cooperate with a network storage device that performs the storage function of the memory 56 through a network connection. The processor 58 generally controls the overall operation of the terminal 50. The power supply unit 59 receives external power or internal power under the control of the processor 58 and provides appropriate power required for operating various elements and components.

The processor 58 executes the programs stored in the memory 56 to perform at least one function application and data processing, for example, to implement the method provided by the embodiments of the present disclosure.

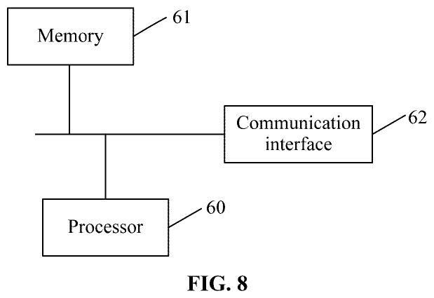

FIG. 8 is a schematic structural diagram of a base station according to an embodiment of the present disclosure. As shown in FIG. 8, the base station includes a processor 60, a memory 61, and a communication interface 62. One or more processors 60 may be provided in the base station, and one processor 60 is used as an example in FIG. 8. The processor 60, the memory 61, and the communication interface 62 that are in the base station may be connected through a bus or in other manners. In FIG. 8, the connection through the bus is taken as an example. The bus represents one or more of several types of bus structures, including a memory bus or a memory controller, a peripheral bus, an accelerated graphics port, a processor, or a local bus using any bus structure among multiple bus structures.

As a computer-readable storage medium, the memory 61 may be configured to store software programs, computer-executable programs and modules, such as program instructions/modules corresponding to the method in the embodiments of the present disclosure. The processor 60 executes the software programs, instructions and modules stored in the memory 61 to perform at least one function application and data processing of the base station, that is, to implement the above methods.

The memory 61 may include a program storage region and a data storage region. The program storage region may store an operating system and an application program required by at least one function. The data storage region may store data created depending on the purpose of a terminal. Additionally, the memory 61 may include a high-speed random-access memory and may further include a non-volatile memory, for example, at least one magnetic disk memory and flash memory or other non-volatile solid-state memories. In some examples, the memory 61 may include memories remotely disposed with respect to the processor 60. These remote memories may be connected to the base station via a network. Examples of the preceding network include, but are not limited to, the Internet, an intranet, a network, a communication network and a combination thereof.

The communication interface 62 may be configured to receive and send data.

The embodiments of the present disclosure further provide a computer-readable storage medium storing a computer program. When the computer program is executed by a processor, the method provided by any embodiment of the present disclosure is implemented.

A computer storage medium in the embodiments of the present disclosure may use any combination of one or more computer-readable media. A computer-readable medium may be a computer-readable signal medium or a computer-readable storage medium. The computer-readable storage medium may be, for example, but is not limited to, an electrical, magnetic, optical, electromagnetic, infrared or semiconductor system, apparatus or device, or any combination thereof. The computer-readable storage medium includes (a non-exhaustive list): an electrical connection having one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical memory device, a magnetic memory device, or any suitable combination thereof. In the present disclosure, the computer-readable storage medium may be any tangible medium including or storing a program. The program may be used by or used in conjunction with an instruction execution system, apparatus or device.

A computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal or any suitable combination thereof. The computer-readable signal medium may further be any computer-readable medium other than the computer-readable storage medium. The computer-readable medium may send, propagate, or transmit the program used by or used in conjunction with the instruction execution system, apparatus, or element.

Program codes included on the computer-readable medium may be transmitted using any suitable medium including, but not limited to, a radio medium, a wire, an optical cable, radio frequency (RF) and the like, or any suitable combination thereof.

Computer program codes for executing the operations of the present disclosure may be written in one or more programming languages or a combination of multiple programming languages. The programming languages include object-oriented programming languages (such as Java, Smalltalk, C++, Ruby and Go) and conventional procedural programming languages (such as “C” or similar programming languages). The program codes may be executed entirely on a user computer, partly on the user computer, as a stand-alone software package, partly on the user computer and partly on a remote computer, or entirely on the remote computer or a server. In the case where the remote computer is involved, the remote computer may be connected to the user computer via any type of network (including a local area network (LAN) or a wide area network (WAN)) or may be connected to an external computer (for example, via the Internet through an Internet service provider).

It is to be understood by those skilled in the art that the term user terminal covers any suitable type of wireless user equipment, for example, a mobile phone, a portable data processing apparatus, a portable web browser, or a vehicle-mounted mobile station.

In general, multiple embodiments of the present disclosure may be implemented in hardware or special-purpose circuits, software, logic, or any combination thereof. For example, some aspects may be implemented in hardware while other aspects may be implemented in firmware or software that may be executed by a controller, a microprocessor, or another computing apparatus, though the present disclosure is not limited thereto.

The embodiments of the present disclosure may be implemented by computer program instructions executed by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present disclosure may represent program steps, may represent interconnected logic circuits, modules, and functions or may represent a combination of program steps with logic circuits, modules, and functions. A computer program may be stored in a memory. The memory may be of any type suitable for a local technical environment and may be implemented using any suitable data storage technology. The memory may be, for example, but not limited to, a read-only memory (ROM), a random-access memory (RAM), an optical storage apparatus and system (digital video disk (DVD) or compact disc (CD)) or the like. Computer-readable media may include non-transitory storage media. The data processor may be of any type suitable for the local technical environment, such as, but not limited to, a general-purpose computer, a special-purpose computer, a microprocessor, a digital signal processor (DSP), an application specific integrated circuit (ASIC), a field-programmable gate array (FPGA) and a processor based on a multi-core processor architecture.

1. A method for processing channel state information (CSI) reports, applied to a first communication node, comprising:
receiving configuration information sent by a second communication node; determining, according to the configuration information, a concurrent quantity of CSI processing units; and
processing the CSI reports using at least one CSI processing unit concurrently, wherein a number of the at least one CSI processing unit is equal to the concurrent quantity.

2. The method according to claim 1, wherein the configuration information comprises at least one of the following:
information of CSI-reference signal (RS) resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition schemes, groups of precoding matrix acquisition schemes, or information for monitoring precoding matrix acquisition schemes.

3. The method according to claim 2, wherein in response to the configuration information comprising the information of the CSI-RS resources or the groups of the CSI-RS resources, determining, according to the configuration information, the concurrent quantity comprises:
determining, according to a quantity of the CSI-RS resources or a quantity of the groups of the CSI-RS resources, the concurrent quantity, and
wherein determining, according to the quantity of the CSI-RS resources or the quantity of the groups of the CSI-RS resources, the concurrent quantity comprises:
determining the concurrent quantity as the quantity of the CSI-RS resources; or,
determining the concurrent quantity as a sum of the quantity of the CSI-RS resources and a preset first value; or,
determining the concurrent quantity as a greater one of the quantity of the CSI-RS resources and a preset second value; or,
determining the concurrent quantity as the quantity of the groups of the CSI-RS resources, wherein the groups of the CSI-RS resources comprises a plurality of CSI-RS groups generated by grouping the CSI-RS resources in a manner of quantity-based even partitioning, or a plurality of CSI-RS groups generated by grouping the CSI-RS resources in a manner of computing-power-requirement-based even partitioning, or a plurality of CSI-RS groups generated by grouping the CSI-RS resources in a manner of CSI-processing-unit-computing-power-based matching partitioning.

4. (canceled)

5. The method according to claim 2, wherein determining, according to the configuration information, the concurrent quantity comprises:
determining, according to the configuration information, a quantity of the precoding matrices or a quantity of the groups of the precoding matrices; and
determining, according to the quantity of the precoding matrices or the quantity of groups of the precoding matrices, the concurrent quantity, and
wherein determining, according to the quantity of the precoding matrices or the quantity of the groups of the precoding matrices, the concurrent quantity comprises:
determining the concurrent quantity as the quantity of the precoding matrices; or,
determining the concurrent quantity as a sum of the quantity of the precoding matrices and a preset third value; or,
determining the concurrent quantity as a greater one of the quantity of the precoding matrices and a preset fourth value; or,
determining the concurrent quantity as the quantity of the groups of the precoding matrices, wherein the groups of the precoding matrices comprise a plurality of precoding matrices groups generated by grouping in a manner of quantity-based even partitioning, or a plurality of precoding matrices groups generated by grouping in a manner of computing-power-requirement-based even partitioning, or a plurality of precoding matrices groups generated by grouping in a manner of CSI-processing-unit-computing-power-based matching partitioning.

6. (canceled)

7. The method according to claim 2, wherein in response to the configuration information being target data, determining, according to the configuration information, the concurrent quantity comprises:
determining the concurrent quantity as a quantity of pieces of the target data, wherein the pieces of the target data comprise one of the codebooks of the precoding matrices, the groups of the codebooks of the precoding matrices, the ranks of the precoding matrices, the groups of the ranks of the precoding matrices, the layers of the precoding matrices, the groups of the layers of the precoding matrices, the overheads of the precoding matrices, the groups of the overheads of the precoding matrices, the machine learning models, the groups of the machine learning models, the frequency domain units, the groups of the frequency domain units, the precoding matrix acquisition schemes, or the groups of the precoding matrix acquisition schemes.

8. The method according to claim 2, wherein determining, according to the configuration information, the concurrent quantity comprises:
determining, according to the configuration information, a quantity of the CSI-RS resources in a CSI-RS resource set corresponding to the CSI reports and a purpose of the precoding matrices in the CSI reports; and
determining, according to the quantity of the CSI-RS resources in the CSI-RS resource set corresponding to the CSI reports and the purpose of the precoding matrices in the CSI reports, the concurrent quantity, and
wherein determining, according to the quantity of the CSI-RS resources in the CSI-RS resource set corresponding to the CSI reports and the purpose of the precoding matrices in the CSI reports, the concurrent quantity comprises:
determining, according to the purpose of the precoding matrices in the CSI reports, a rule corresponding to the purpose of the precoding matrices in the CSI reports; and
determining, according to the rule corresponding to the purpose of the precoding matrices in the CSI reports and the quantity of the CSI-RS resources in the CSI-RS resource set corresponding to the CSI reports, the concurrent quantity.

9. (canceled)

10. The method according to claim 2, wherein determining, according to the configuration information, the concurrent quantity comprises:
determining, according to the configuration information, a quantity of the CSI-RS resources in the CSI reports and the quantity of the precoding matrices corresponding to the CSI-RS resources in the CSI reports; and
determining, according to a comparison between the quantity of the CSI-RS resources in the CSI reports and the quantity of the precoding matrices corresponding to the CSI-RS resources in the CSI reports, the concurrent quantity, and
wherein determining, according to the comparison between the quantity of the CSI-RS resources in the CSI reports and the quantity of the precoding matrices corresponding to the CSI-RS resources in the CSI reports, the concurrent quantity comprises:
in response to the quantity of the CSI-RS resources in the CSI reports being less than the quantity of the precoding matrices corresponding to the CSI-RS resources in the CSI reports, determining, according to a first preset rule, the concurrent quantity; and
in response to the quantity of the CSI-RS resources in the CSI reports being greater than or equal to the quantity of the precoding matrices corresponding to the CSI-RS resources in the CSI reports, determining, according to a second preset rule, the concurrent quantity.

11. (canceled)

12. The method according to claim 10, wherein the first preset rule is: determining the concurrent quantity as a difference value obtained by subtracting a fifth value from a sum of the quantity of the CSI-RS resources in the CSI-RS resource set corresponding to the CSI reports and the quantity of the precoding matrices corresponding to the CSI-RS resources in the CSI reports; and
the second preset rule is determining the concurrent quantity as a product of the quantity of the CSI-RS resources in the CSI-RS resource set corresponding to the CSI reports and the quantity of the precoding matrices corresponding to the CSI-RS resources in the CSI reports.

13. The method according to claim 2, wherein determining, according to the configuration information, the concurrent quantity comprises:
determining, according to the configuration information, a quantity of the CSI-RS resources in a CSI-RS resource set corresponding to the CSI reports and a quantity of the precoding matrices in the CSI reports; and
determining, according to the quantity of the CSI-RS resources in the CSI-RS resource set corresponding to the CSI reports and the quantity of the precoding matrices in the CSI reports, the concurrent quantity, and
wherein determining, according to the quantity of the CSI-RS resources in the CSI-RS resource set corresponding to the CSI reports and the quantity of the precoding matrices in the CSI reports, the concurrent quantity comprises:
determining the concurrent quantity as a greater one of the quantity of the CSI-RS resources in the CSI-RS resource set corresponding to the CSI reports and the quantity of the precoding matrices in the CSI reports; or,
determining the concurrent quantity as a greater one of a processed quantity of the CSI-RS resources in the CSI-RS resource set corresponding to the CSI reports and a processed quantity of the precoding matrices in the CSI reports; or,
determining a concurrent quantity of first-type CSI processing units as a processed quantity of the CSI-RS resources in the CSI-RS resource set corresponding to the CSI reports, and determining a concurrent quantity of second-type CSI processing units as the processed quantity of the precoding matrices in the CSI reports.

14. (canceled)

15. The method according to claim 2, wherein determining, according to the configuration information, the concurrent quantity comprises:
determining, according to the configuration information, a quantity of the CSI-RS resources in a CSI-RS resource set corresponding to the CSI reports and a quantity of precoding matrix indicators in the CSI reports; and
determining, according to the quantity of the CSI-RS resources in the CSI-RS resource set corresponding to the CSI reports and the quantity of the precoding matrix indicators in the CSI reports, the concurrent quantity.

16. The method according to claim 2, wherein determining, according to the configuration information, the concurrent quantity comprises:
determining, according to the configuration information, a range of candidate indexes of the CSI-RS resources in the CSI reports; and
determining the concurrent quantity according to the range of the candidate indexes of the CSI-RS resources in the CSI reports.

17. The method according to claim 2, wherein determining, according to the configuration information, the concurrent quantity comprises:
determining a CSI report group according to the configuration information; wherein the CSI reports in the CSI report group have a same candidate CSI-RS resource set, or the CSI-RS resources corresponding to the CSI reports in the CSI report group are the same, or the CSI reports in the CSI report group have a same priority; and
determining the concurrent quantity according to the CSI report group.

18. The method according to claim 2, wherein determining, according to the configuration information, the concurrent quantity comprises:
determining a required processing time duration of the CSI reports according to the configuration information; and
determining the concurrent quantity according to the required processing time duration of the CSI reports.

19. The method according to claim 2, wherein determining, according to the configuration information, the concurrent quantity comprises:
determining a subcarrier spacing according to the configuration information; and
determining the concurrent quantity according to the subcarrier spacing.

20. The method according to claim 1, wherein the concurrent quantity comprises a concurrent quantity of at least two types of the CSI processing units.

21. A method for processing channel state information (CSI) reports, applied to a second communication node, comprising:
sending configuration information to a first communication node; and
receiving the CSI reports processed according to the configuration information and sent by the first communication node, wherein the CSI reports are processed by the first communication node using at least one CSI processing unit concurrently, the number of the at least one CSI processing unit is equals to a concurrent quantity of CSI processing units and the concurrent quantity is determined by the first communication node according to the configuration information.

22. The method of claim 21, wherein the configuration information comprises at least one of the following:
information of CSI-reference signal (RS) resources, groups of CSI-RS resources, codebooks of precoding matrices, groups of codebooks of precoding matrices, ranks of precoding matrices, groups of ranks of precoding matrices, layers of precoding matrices, groups of layers of precoding matrices, overheads of precoding matrices, groups of overheads of precoding matrices, machine learning models, groups of machine learning models, frequency domain units, groups of frequency domain units, precoding matrix acquisition schemes, groups of precoding matrix acquisition schemes, or information for monitoring precoding matrix acquisition schemes.

23. A communication node comprising: a processor, wherein the processor, when executing a computer program, is configured to implement a method for processing channel state information (CSI) reports comprising the following:
receiving configuration information sent by a second communication node; determining, according to the configuration information, a concurrent quantity of CSI processing units; and
processing the CSI reports using at least one CSI processing unit concurrently, wherein a number of the at least one CSI processing unit is equal to the concurrent quantity.

24. A communication node comprising: a processor; wherein the processor, when executing a computer program, is configured to implement the method according to claim 21.

25. A non-transitory computer-readable storage medium, storing a computer program, wherein the computer program, when executed by a processor, implements the method according to claim 1.
